(19) United States
(12) Patent Application Publication
(10) Pub. No.: US 2024/0223421 A1
(43) Pub. Date: Jul. 4, 2024

(54) SYSTEMS AND METHODS/PROCESSES FOR OPTICAL INTERFEROMETRIC SENSING

(71) Applicant: Australian National University, Acton (AU)

(72) Inventors: Anneshwa Dey, Acton (AU); Chathura Priyankara Bandutunga, Acton (AU); Ya Zhang, Acton (AU); Malcolm Bruce Gray, Acton (AU); Jong Hann Chow, Acton (AU); Justin Chak Tin Wong, Acton (AU); Paul George Sibley, Acton (AU)

(21) Appl. No.: 18/691,450

(22) PCT Filed: Aug. 30, 2022
(86) PCT No.: PCT/AU2022/051060

§ 371 Date: Mar. 12, 2024

(30) Foreign Application Priority Data
Aug. 31, 2021 (AU) 2021902822

(51) Int. Cl. H04L 27/22; G02F 1/21; H04L 27/20

(52) U.S. Cl. CPC H04L 27/223; G02F 1/211; H04L 27/2096

(57) ABSTRACT

Systems and methods/processes for optical interferometric sensing using digitally enhanced interferometry (DI).

### RELATED APPLICATION

This complete application is related to Australian Provisional Patent Application No. 2021902822, the originally filed specification of which is hereby incorporated herein by reference in its entirety.

### TECHNICAL FIELD

The present disclosure relates to systems and methods/processes for optical interferometric sensing using digitally enhanced interferometry (DI).

### BACKGROUND

In digitally enhanced interferometry (DI), the correlation properties of a pseudo-random sequence are used to enable time-of-flight based ranging and selective recovery of an optical interference signal.

Existing systems and methods/processes for DI sensing include: modulation of a portion of an optical beam in an interferometer by the pseudo-random sequence; transmission of the beam through an optical system (e.g., including a Michelson interferometer, a Mach-Zehnder interferometer and/or Sagnac interferometer); detection of the transmitted beam; and demodulation of the detected beam to measure interference.

However, existing systems and methods/processes may be limited undesirably by noise generated in the optical system (including coherent coupling of spurious noise), by crosstalk between signals, and/or by noise generated in the demodulation system (“code noise”).

It is desired to address or ameliorate one or more disadvantages or limitations associated with existing systems and methods/processes, or to at least provide a useful alternative.

### SUMMARY

Described herein is a system (for optical interferometric sensing using digitally enhanced interferometry (DI)), the system including:
an optical source configured to provide at least one first optical beam (e.g., one or more signal beams or reference beams) and at least one second optical beam (e.g., one or more reference beams or signal beams selected to cooperate with the first optical beam(s) for the optical interferometric sensing);
an interferometer (configured for the optical interferometric sensing, e.g., as a Mach-Zehnder (MZ) interferometer or a Sagnac interferometer) including:
   at least one first optical path for the at least one first optical beam,
   at least one second optical path for the at least one second optical beam,
   at least one modulator configured to modulate (optically) the first optical beam and/or the second optical beam based on (a first modulation signal from a signal generator representing) at least one digital modulation sequence, and
   an optical combiner/detector configured to detect interference fringes between the first and second optical beams after the first and second optical beams have traversed the first and second optical paths (and after the at least one first optical beam and/or the at least one second optical beam have/has been modulated by the at least one modulator, depending on the configuration of the interferometer); and
   an electronic processing system including:
   a receiver element (“receiver”) configured to receive from the optical combiner/detector an interference signal that is indicative of an interferometer phase, which is an optical phase difference between the first and second optical beams,
   a demodulator configured to obtain/generate at least one decoding output by demodulating the interference signal using at least one digital demodulation sequence that is associated with (e.g., mathematically based on) the at least one digital modulation sequence, and
   a phase output element configured to determine/generate the interferometer phase based on the at least one decoding output,
wherein the at least one digital modulation sequence or the at least one digital demodulation sequence is based on a plurality of digital sequences (e.g., is formed from the plurality of digital sequences), which include a first digital sequence and a second digital sequence, wherein the second digital sequence is based on a time-shifted version of the first digital sequence by an offset delay, and
wherein (including for mitigating noise and/or crosstalk from the interferometer at non-signal delays):
   the offset delay is selected to correspond to a delay not already associated with a physical signal in the interferometer; or
   the at least one digital modulation sequence or the at least one digital demodulation sequence includes a compound digital sequence based on the first digital sequence and the second digital sequence combined according to a linear algebraic operation (and the other of the at least one digital modulation sequence or the at least one digital demodulation sequence includes just the first digital sequence or the second digital sequence, i.e., uncombined); or
   the first optical beam and/or the second optical beam are modulated (e.g., using a plurality of the least one modulator configured to modulate the first optical beam and/or the second optical beam, e.g., two modulators on one beam, or one modulator on each beam) and combined according to a linear algebraic operation (#) (e.g., combined by modulating one beam according to (#) if the modulators act on the one beam, or optically combined according (#) if the modulators act on separate beams); or
   a plurality of the at least one decoding output (e.g., two decoding outputs) are combined according to a linear algebraic operation (#).

(The offset delay may be selected to correspond to a delay not already associated with a physical signal in the interferometer in combination with any of the digital modulation/demodulation or encoding/decoding configurations.) The system may include a sequence source configured to generate the first digital sequence, the second digital sequence, and/or the compound digital sequence for the modulation and/or the demodulation. The electronic processing system and/or the sequence source may be configured to generate the second digital sequence by time shifting the first modulation sequence by the offset delay (To). (The second digital sequence can be generated and time-shifted anywhere in the system, not just the decoder.)

The system may include any one or more of:
an optical splitter configured to split a light beam from the optical source into the first optical beam and the second optical beam, or a plurality of phase-coherent optical sources that provide the first optical beam and/or the second optical beam;
a first modulator configured to modulate the first optical beam in the first optical path based on the digital modulation sequence (which may be the first digital sequence or the compound digital sequence);
an optical length difference between the first optical path and the second optical path to provide different travel times for the first optical beam and the second optical beam, and a modulator arranged and configured to modulate both the first optical beam and the second optical beam before they are split by a/the optical splitter;
a first modulator (arranged and configured to modulate the first optical beam) driven by a first signal generator with a first version of the digital modulation sequence (which may be the first digital sequence or the compound digital sequence), and a second modulator (arranged and configured to modulate the second optical beam) driven by a second signal generator with a second version of the digital modulation sequence that is a digitally delayed version of the first version; and
a Sagnac interferometer with two modulators that both modulate both of the first and second optical beams, and a time delay element in an optical path between the two modulators.

The first digital sequence may be configured/adapted/selected to have an autocorrelation (i.e., the properties of the autocorrelation are) such that a sample-by-sample linear combination (i.e., the combination is made sample by sample) according to the linear algebraic operation (#) of two time-shifted versions of the autocorrelation substantially equal zero for non-signal delays, i.e., delays in the interferometer excluding the signal delay (Ts).

The plurality of the at least one decoding output may include: a first decoding output and a second decoding output. The first decoding output and the second decoding output are combined according to the linear algebraic operation (#). The electronic processing system may be configured to obtain/generate the first decoding output and the second decoding output in parallel, i.e., by decoding the interference signal in parallel (e.g., performing/executing/carrying out the two demodulating operations in parallel and at the same time, i.e., simultaneously), optionally wherein the electronic processing system includes two parallel demodulation channels, including: a first demodulation channel configured to obtain the first decoding output by the demodulating of the interference signal using the first digital sequence, and a second demodulation channel configured to obtain the second decoding output by the demodulating of the interference signal using the second digital sequence.

The first digital sequence may have a sequence length (total number of symbols) and a symbol rate selected based on a predetermined required bandwidth of the interferometer, e.g., predetermined for an interferometric application.

The first digital sequence may have a physical sequence length (i.e., a physical space/length occupied by the code sequence in an optical system) that is at least as large as a selected range of distance measurements to be made (or being made when in use) by the interferometer (e.g., a preselected range in a ranging application).

The first digital sequence may have a physical sequence length that is substantially equal to or larger than a larger of the at least one first optical path and the at least one second optical path (i.e., the optical paths in the interferometer), optionally wherein the offset delay (To) is selected to represent a distance equal to or larger than the at least one first optical path and the at least one second optical path (i.e., the optical paths in the interferometer).

The sequence source may include a pseudo-random number generator and/or a linear feedback shift register optionally on a Field-Programmable Gate Array (FPGA) or a digital signal processing (DSP) module configured to generate the first digital sequence and optionally the second digital sequence.

The offset delay (To) and the linear algebraic operation (#) may be selected based on properties of the first digital sequence. For example, the first digital sequence may be in the form of an A1-sequence or an A2-sequence, in which case the linear algebraic operation (#) may be selected to include an addition or a subtraction, and/or wherein the offset delay (To) may be selected to include: 2k+1 or 2k+2 symbols, or 4k+4 or 4k+4 symbols (wherein k is an integer number), or 1 symbol (e.g., when a first digital delay (T1) between the modulator and the demodulator is shifted+/−½ symbols from matching an optimal signal delay (Ts) provided by the interferometer). For example, the compound digital modulation sequence may be in the form of a linear combination of A1-sequences or of A2-sequences, wherein the linear combination includes an addition or a subtraction. The first digital sequence may be in the form of an M-sequence with a sequence length (L), in which case the linear algebraic operation (#) may be selected to include a subtraction, and/or wherein the offset delay (To) may be selected to include a value equal or greater than 1 symbol, and less than the sequence length (L). For example, the compound digital modulation sequence may be in the form of a linear combination of two M-sequences with a sequence length (L), wherein the linear combination includes a subtraction.

The first digital sequence may include a pseudo-random sequence, and/or may modulate the interferometer phase with a peak-to-peak modulation depth of up to pi radians. The first digital sequence may include a pseudo-random sequence (including a pseudo-random number sequence) that modulates the interferometer phase with a peak-to-peak modulation depth of up to pi radians.

The compound digital sequence may include a linear combination of pseudo-random sequences, and/or may modulate the interferometer phase with a peak-to-peak modulation depth of up to 2pi radians. The compound digital sequence may include a linear combination of pseudo-random sequences (including pseudo-random number sequences) and may modulate the interferometer phase with a peak-to-peak modulation depth of up to 2pi radians.

The interferometer may be configured for digitally-enhanced homodyne interferometry (DEHoI), and the first digital sequence may include a pseudo-random sequence that modulates equally both an in-phase component and a quadrature component of the first optical beam and/or the second optical beam such that autocorrelation properties of the pseudo-random sequence are independently preserved in both the in-phase component and the quadrature component (i.e., the autocorrelation properties are preserved in the components of the beams) and in in-phase and quadrature readouts (I and Q) of the electronic processing system.

The first digital sequence may include: a predictable, repetitive/periodic, deterministic (non-random) phase modulation (“regular modulation”) combined with the pseudo-random sequence, wherein the regular modulation has an integer number of periods and is synchronous with the symbol frequency of the first digital modulation sequence, optionally wherein the regular modulation modulates the interferometer phase with a peak-to-peak modulation depth of up to pi/2 radians. The compound digital sequence may include: a predictable, repetitive/periodic, deterministic (non-random) phase modulation (“regular modulation”) combined with the first digital sequence and the second digital sequence (which can be pseudo-random sequences) combined according to the linear algebraic operation (#), wherein the regular modulation has an integer number of periods and is synchronous with the symbol frequency of the compound digital sequence, optionally wherein the regular modulation modulates the interferometer phase with a peak-to-peak modulation depth of up to pi/2 radians.

Described herein is a method/process (for optical interferometric sensing using digitally enhanced interferometry (DI)), the method/process including:
providing at least one first optical beam and at least one second optical beam;
modulating the first optical beam and/or the second optical beam based on at least one digital modulation sequence;
detecting interference fringes between the first and second optical beams after the first and second optical beams have traversed an interferometer and been modulated;
receiving an interference signal that is indicative of an optical phase difference between the first and second optical beams;
obtaining/generating at least one decoding output by demodulating the interference signal using at least one digital demodulation sequence that is associated with the at least one digital modulation sequence; and
determining the interferometer phase based on the at least one decoding output,
wherein the at least one digital modulation sequence or the at least one digital demodulation sequence is based on a plurality of digital sequences (i.e., is formed from the plurality of digital sequences), which include a first digital sequence and a second digital sequence, wherein the second digital sequence is based on a time-shifted version of the first digital sequence by an offset delay, and
wherein (including for mitigating noise and/or crosstalk from the interferometer at non-signal delays):
   the offset delay is selected to correspond to a delay not already associated with a physical signal in the interferometer; or
   the at least one digital modulation sequence or the at least one digital demodulation sequence includes a compound digital sequence based on the first digital sequence and the second digital sequence combined according to a linear algebraic operation (#) (and the other of the at least one digital modulation sequence or the at least one digital demodulation sequence includes just the first digital sequence or the second digital sequence, i.e., uncombined); or
   the first optical beam and/or the second optical beam are modulated (e.g., using a plurality of the least one modulator configured to modulate the first optical beam and/or the second optical beam, e.g., two modulators on one beam, or one modulator on each beam) and combined according to a linear algebraic operation (#); or
   a plurality of the at least one decoding output (e.g., two decoding outputs) are combined according to a linear algebraic operation (#).

### BRIEF DESCRIPTION OF THE DRAWINGS

Preferred embodiments of the present invention are hereinafter described, by way of non-limiting example only, with reference to the accompanying drawings, in which:

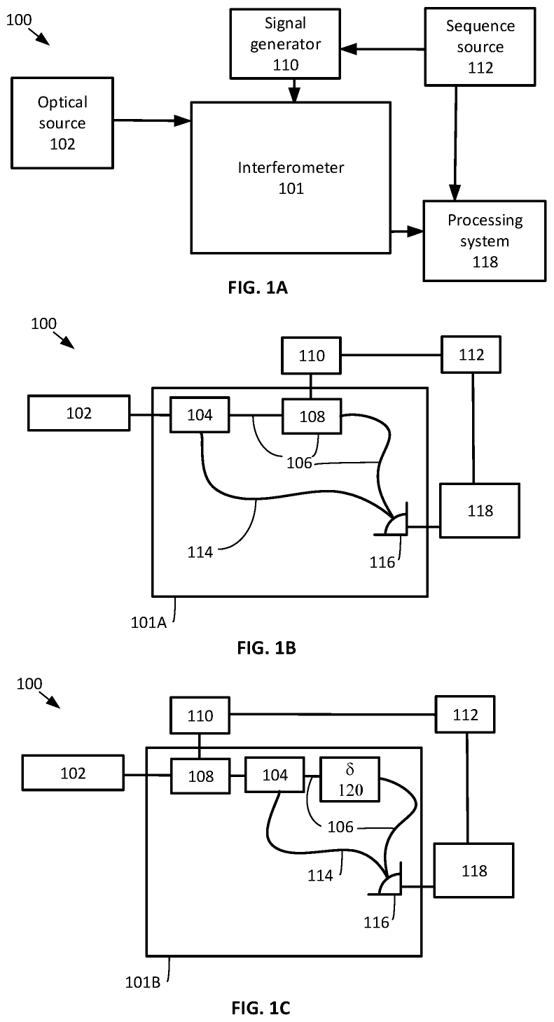

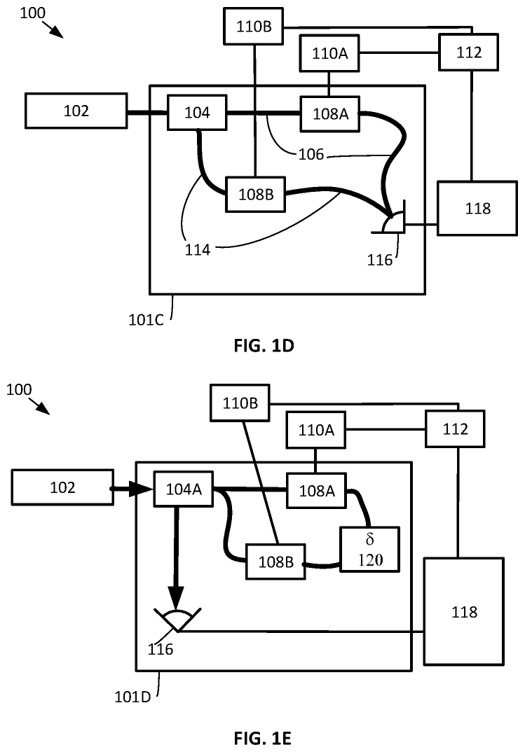

(a) FIG. 1A is a block diagram of a system described herein, which may be an Offset Modulation System or an Offset Demodulation System;

(b) FIG. 1B is a block diagram of the system including a Mach-Zehnder (MZ) interferometer (MZI) with modulation in one arm;

(c) FIG. 1C is a block diagram of the system including a MZ interferometer with common modulation of both arms and a time delay in one arm;

(d) FIG. 1D is a block diagram of the system including a MZ interferometer with mutually independent modulation in both arms;

(e) FIG. 1E is a block diagram of the system including a Sagnac interferometer with a time delay;

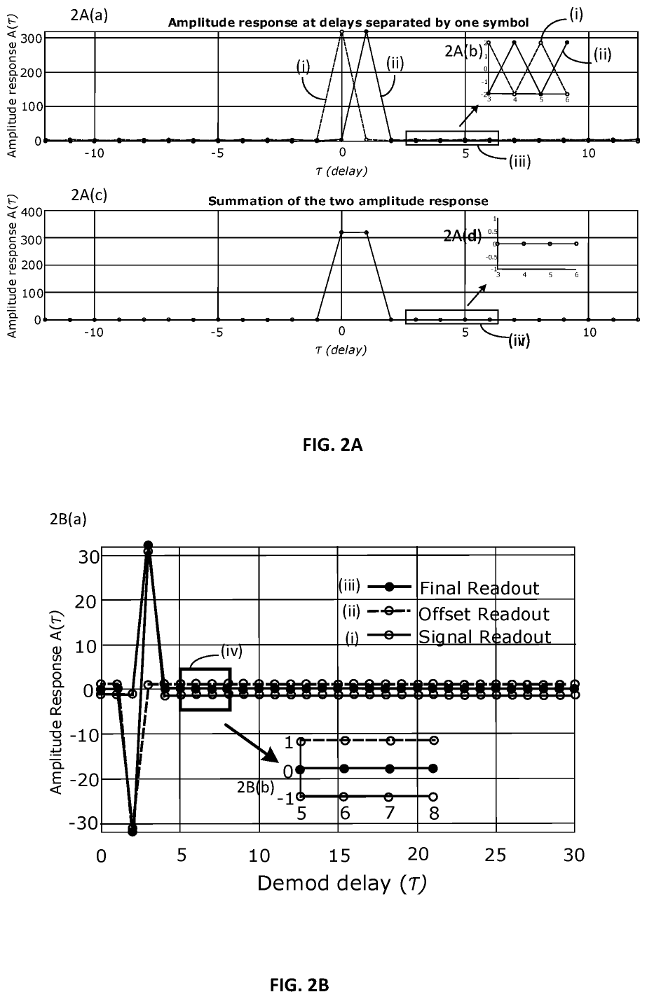

(f) FIG. 2A(a) is an amplitude plot of: a first correlation (i) between a time-domain interference signal and a first modulation sequence; and a second correlation (ii) between the time-domain interference signal and a second (de)modulation sequence (in the form of an A1 code) that is an offset version (i.e., a time-delayed version) of the first modulation sequence, offset by one code symbol (i.e., having a relative offset of one code symbol); with a selected portion (iii) at non-signal delays;

(g) FIG. 2A(b) is a selected portion (iii) of FIG. 2A(a) with an expanded Y axis showing the oscillatory nature of the residual spurious response for non-signal delays;

(h) FIG. 2A(c) is an amplitude plot of a linear combination (a summation) of (i) and (ii) of FIG. 2A(a); with a selected portion (iv) at non-signal delays;

(i) FIG. 2A(d) is a selected portion (iv) of FIG. 2A(c) with an expanded Y axis showing the two oscillating spurious signals cancel out due to the linear combination (summation);

(j) FIG. 2B(a) is an amplitude plot of: (i) a first correlation between a time-domain interference signal and a first modulation sequence (in the form of an M-sequence); (ii) a second correlation between the time-domain interference signal and a second (de)modulation sequence that is an offset version (i.e., a time-delayed version) of the first modulation sequence, offset by minus 1 code symbol (i.e., having a relative offset of minus one code symbol); and (iii) a linear combination (in the form of a subtraction at each demodulation delay, i.e., subtraction of the two demodulation channels) of the first correlation and the second correlation;

(k) FIG. 2B(b) is a selected portion (iv) of FIG. 2B(a) with an expanded Y axis showing the two spurious signals cancel out due to the linear combination (subtraction);

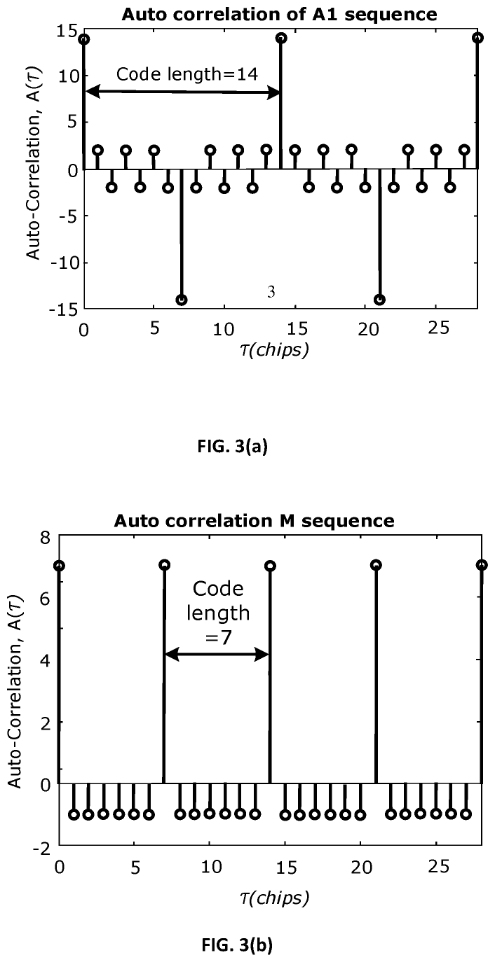

(l) FIG. 3(a) is a plot of an autocorrelation profile of a bipolar A1-sequence with a code length of 14;

(m) FIG. 3(b) is a plot of an autocorrelation profile of an M sequence;

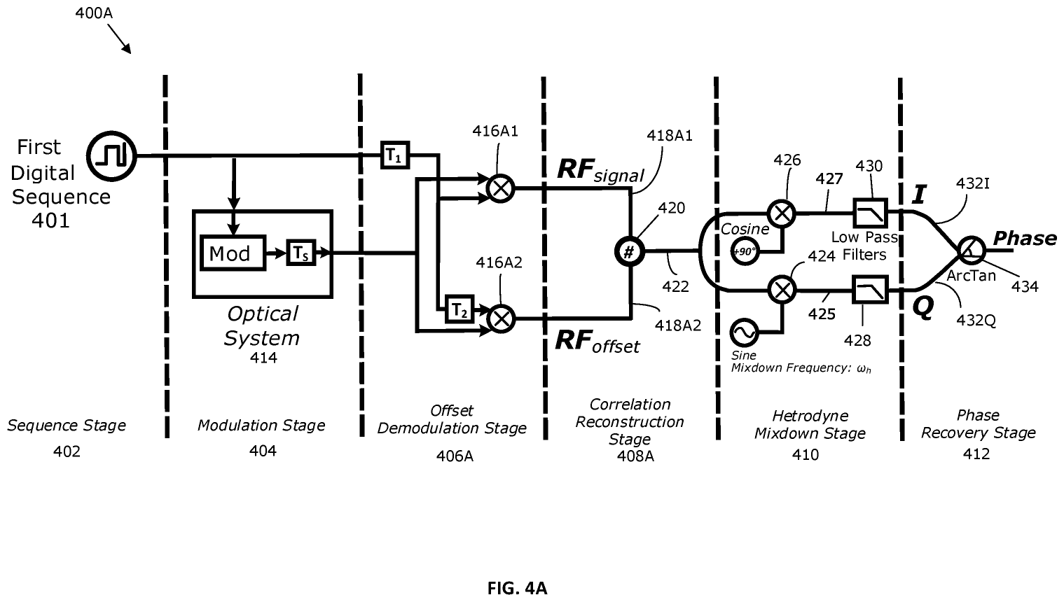

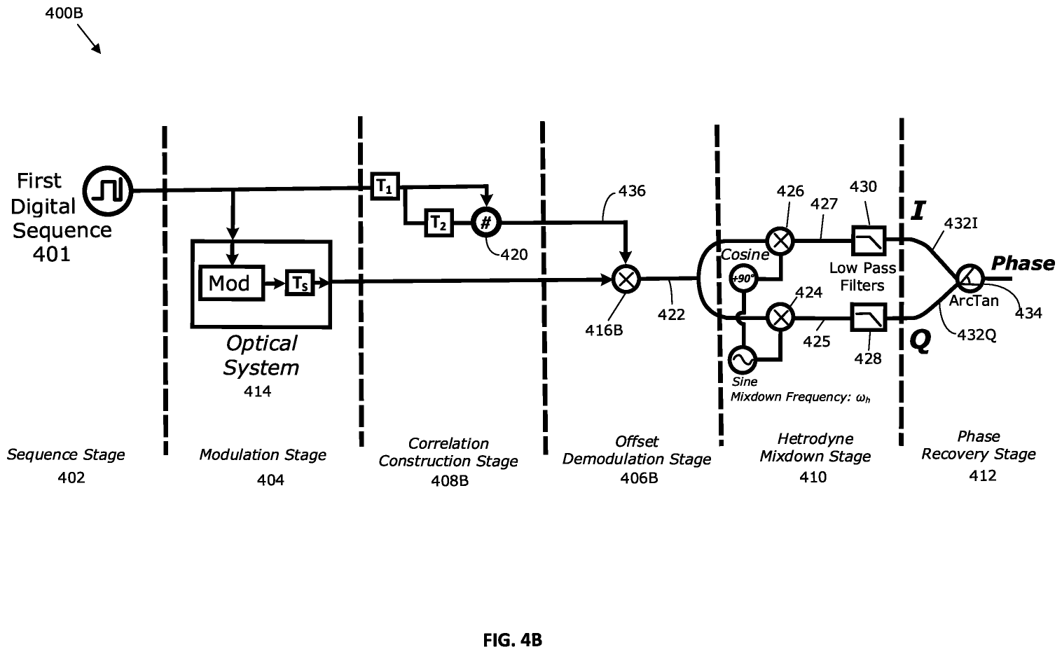

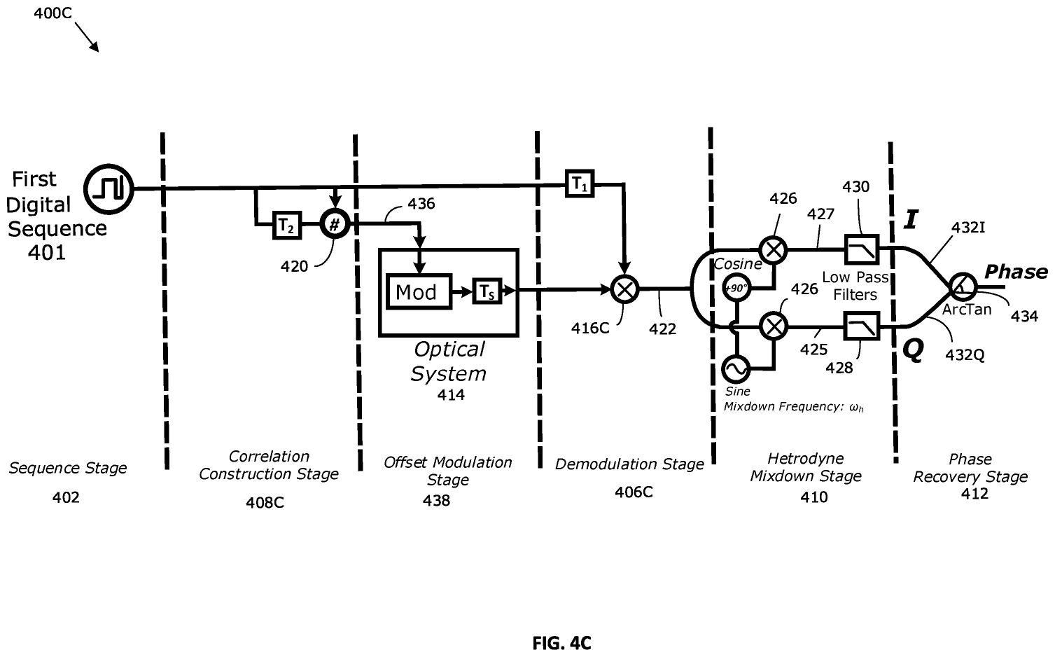

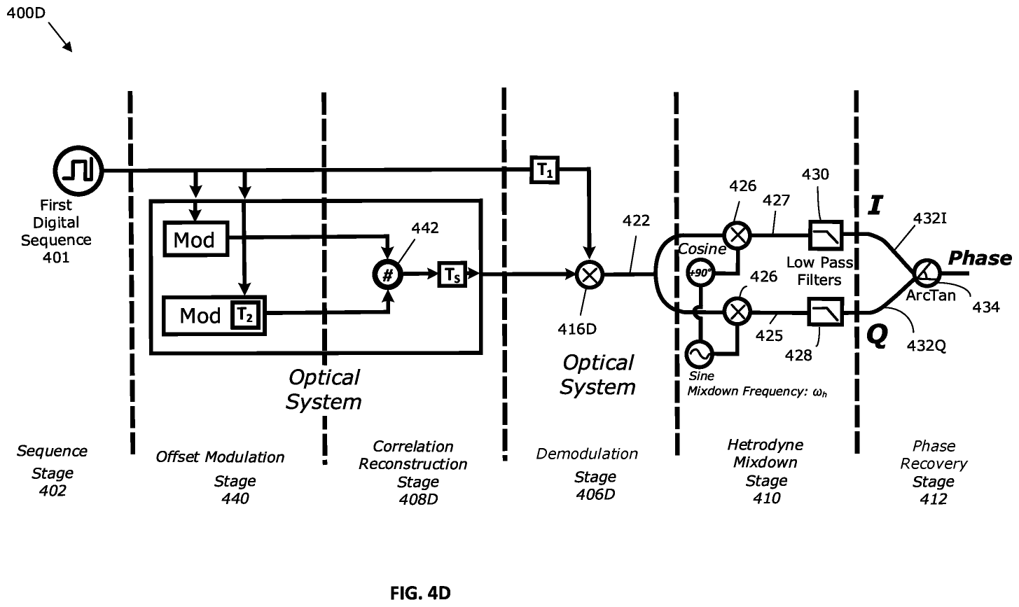

(n) FIG. 4A is a schematic diagram of an electronic processing system of a heterodyne implementation of the Offset Demodulation System, using a linear combination of digital sequences to demodulate the detected signal and implemented using two separate demodulation sequences and respectively two parallel demodulation/decoding channels;

(o) FIG. 4B is a schematic diagram of an electronic processing system of a heterodyne implementation of the Offset Demodulation System, using a linear combination of digital sequences to demodulate the detected signal and implemented using a single compound digital demodulation sequence;

(p) FIG. 4C is a schematic diagram of an electronic processing system of a heterodyne implementation of the Offset Modulation System, using a linear combination of digital sequences to modulate the optical source and implemented using a single compound digital modulation sequence;

(q) FIG. 4D is a schematic diagram of an electronic processing system of a heterodyne implementation of the Offset Modulation System, using a linear combination of digital sequences to modulate the optical source and implemented using two separate modulation sequences and respectively two parallel modulation/encoding channels;

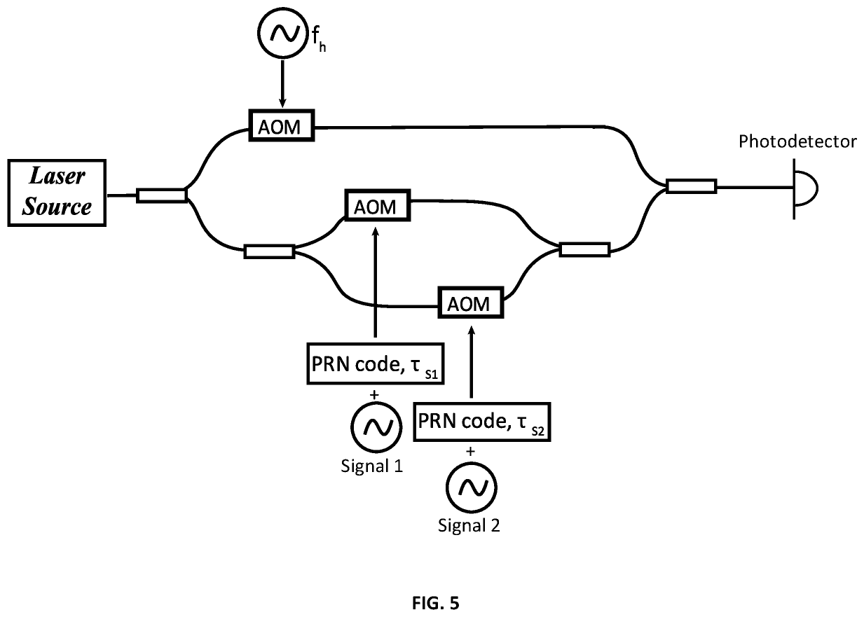

(r) FIG. 5 is an optical system diagram of an experimental implementation of the heterodyne system;

(s) FIG. 6(a) is a plot of phase spectral density of signals recovered without offset decoding;

(t) FIG. 6(b) is a plot of phase spectral density of signals recovered with offset decoding for the same input frequencies as in FIG. 6(a);

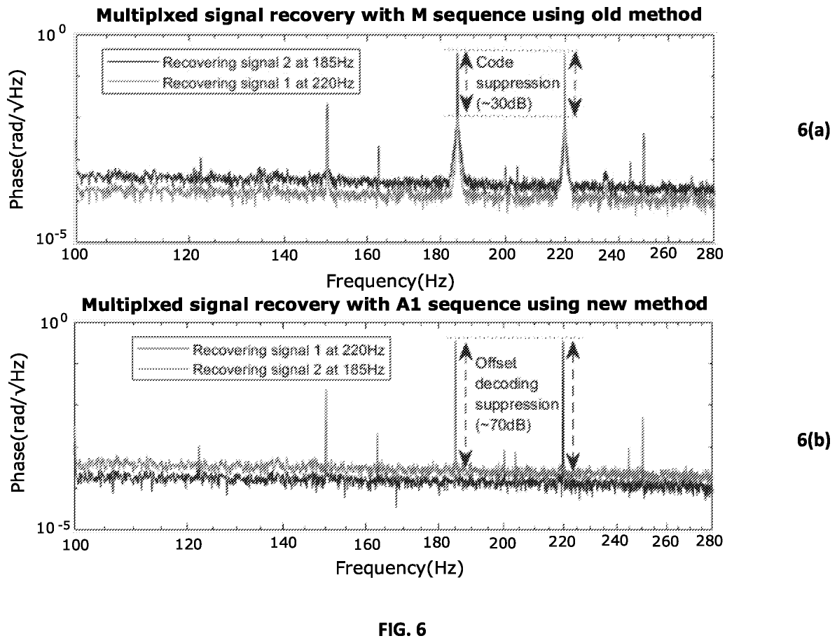

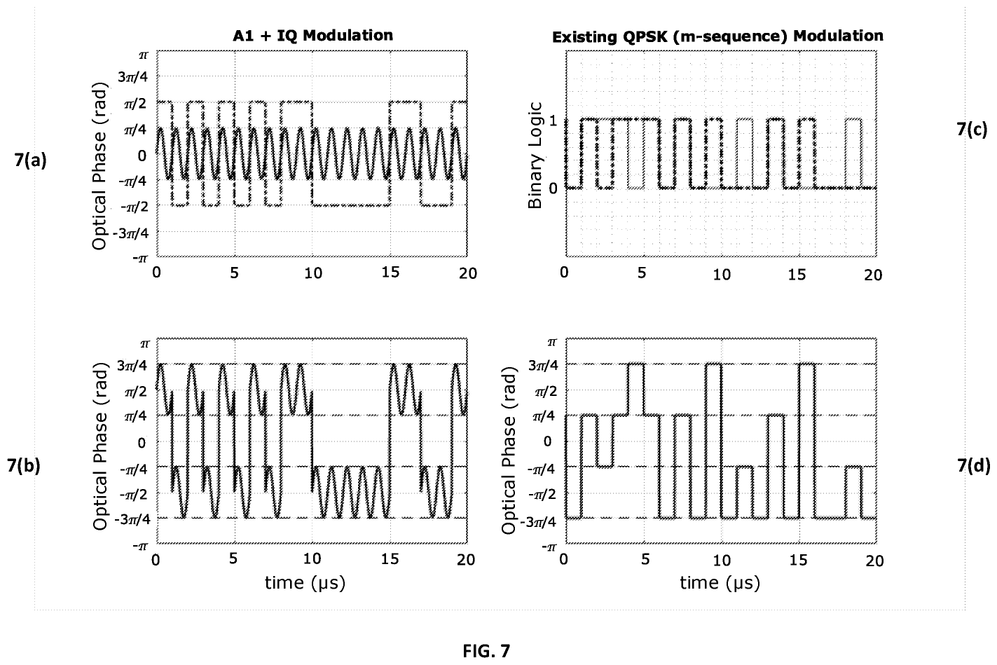

(u) FIG. 7(a) is an optical phase vs time plot of a first modulation sequence (binary A1-sequence) superimposed on an IQ modulation signal;

(v) FIG. 7(b) is an optical phase vs time plot of a quasi-4-level modulation generated by adding in phase the sequence and signal of FIG. 7(a);

(w) FIG. 7(c) is an optical phase vs time plot of two M-sequences in existing QPSK modulation;

(x) FIG. 7(d) is an optical phase vs time plot of a quasi-4-level modulation generated by adding in phase the two sequences of FIG. 7(c);

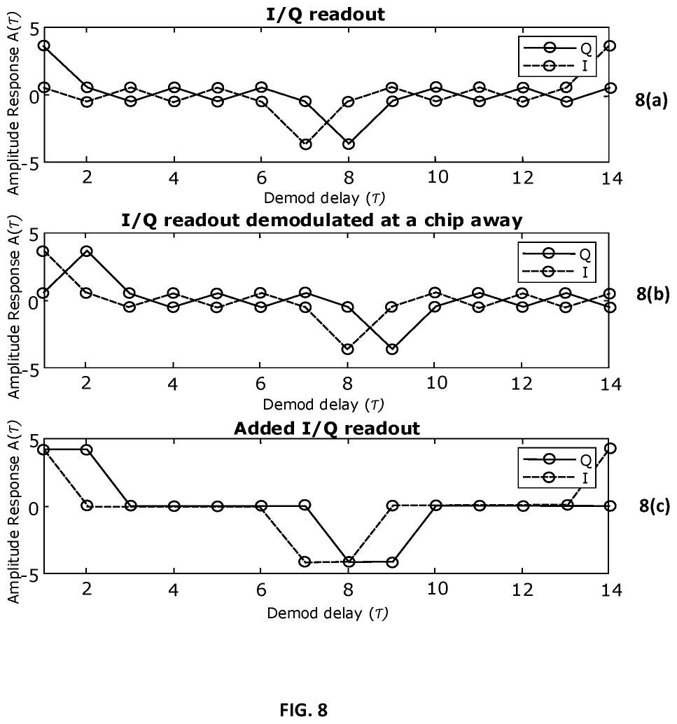

(y) FIG. 8(a) is an amplitude response plot showing I and Q signals at the I/Q readout for a homodyne system with an X axis in ½ chip/code units as I and Q are offset by ½ a chip due to predictable, repetitive/periodic, deterministic phase modulation as shown in FIGS. 7(a) and 7(b);

(z) FIG. 8(b) is an amplitude response plot showing the I and Q signals from FIG. 8(a) at the I/Q readout with a 1-chip delay;

(aa) FIG. 8(c) is an amplitude response plot showing an algebraic combination of the I and Q signals from FIGS. 8(a) and 8(b);

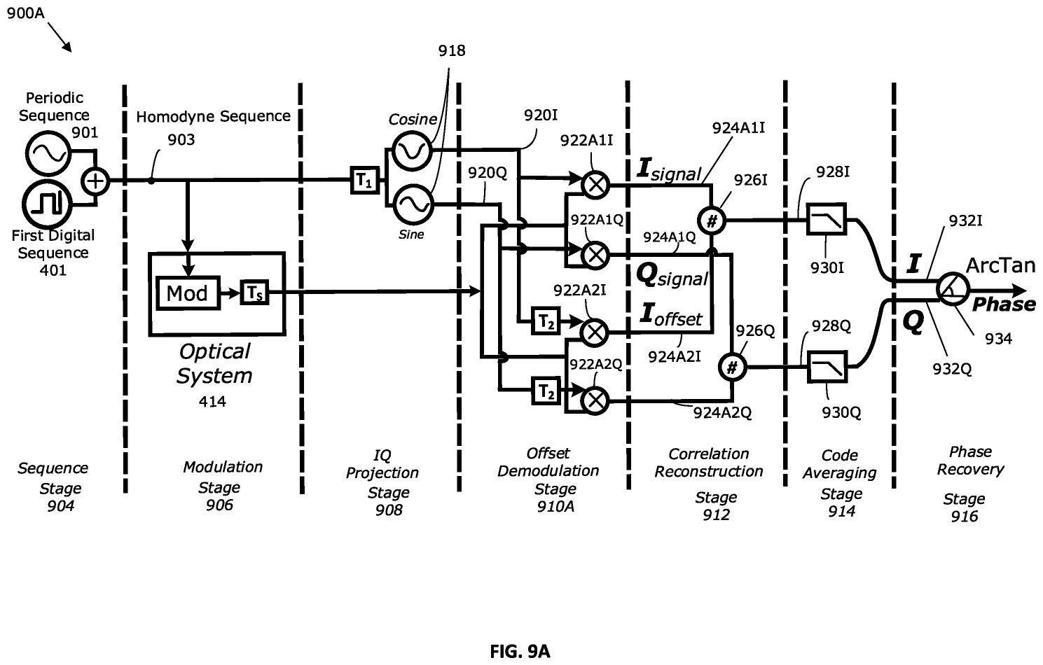

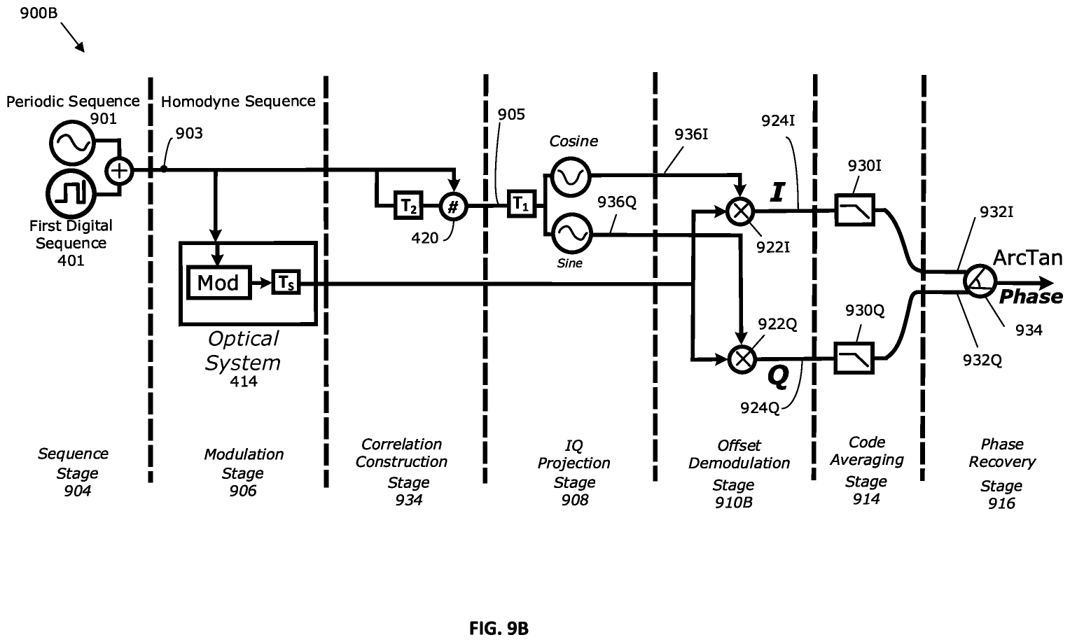

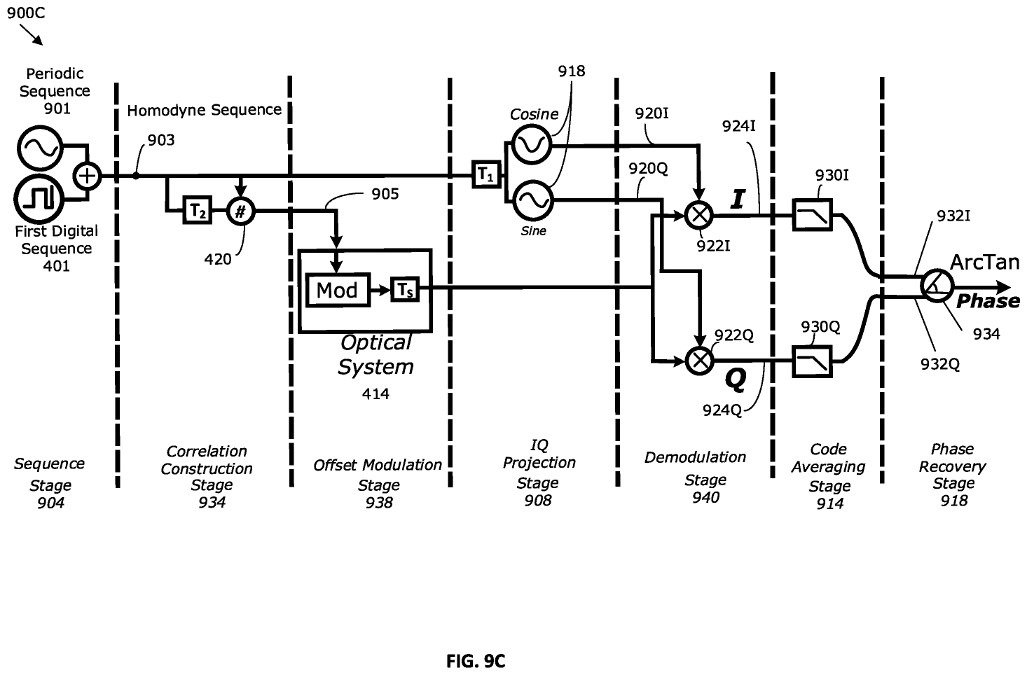

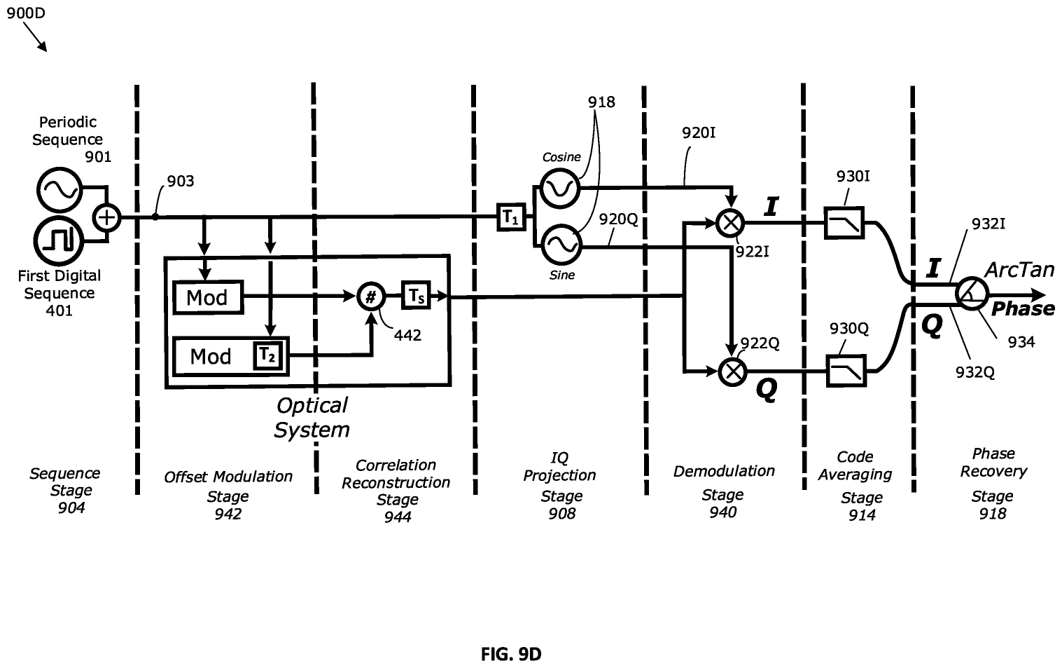

(bb) FIG. 9A is a schematic diagram of an electronic processing system of a homodyne implementation of the Offset Demodulation System, using a linear combination of digital sequences to demodulate the detected signal and implemented using two separate demodulation sequences and respectively two parallel demodulation/decoding channels;

(cc) FIG. 9B is a schematic diagram of an electronic processing system of a homodyne implementation of the Offset Demodulation System, using a linear combination of digital sequences to demodulate the detected signal and implemented using a single compound digital demodulation sequence;

(dd) FIG. 9C is a schematic diagram of an electronic processing system of a homodyne implementation of the Offset Modulation System, using a linear combination of digital sequences to modulate the optical source and implemented using a single compound digital modulation sequence;

(ee) FIG. 9D is a schematic diagram of an electronic processing system of a homodyne implementation of the Offset Modulation System, using a linear combination of digital sequences to modulate the optical source and implemented using two separate modulation sequences and respectively two parallel modulation/encoding channels;

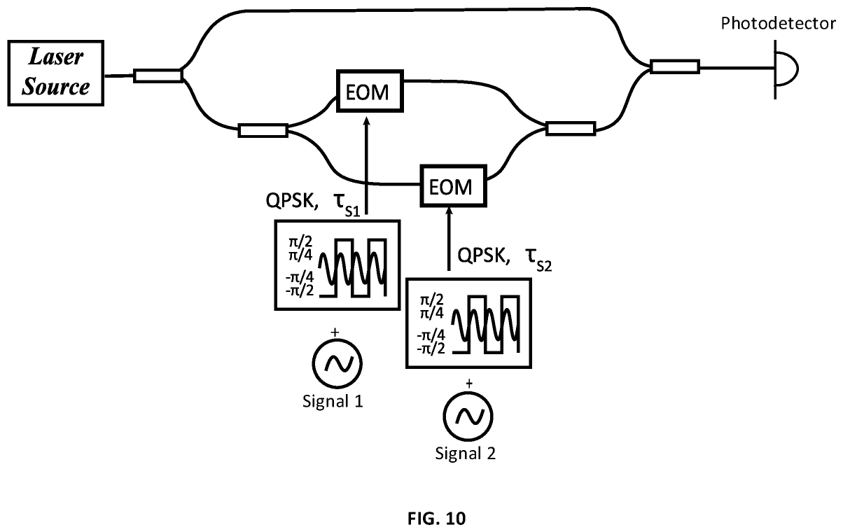

(ff) FIG. 10 is an optical system diagram of an experimental implementation of the homodyne system in this case with an MZ interferometer with mutually independent modulation in both signal arms, and no modulation in the reference arm (i.e., an unmodulated reference arm);

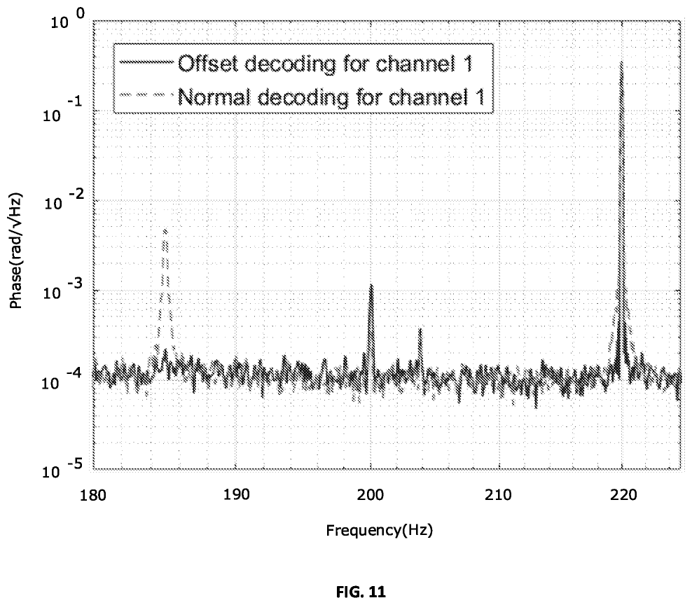

(gg) FIG. 11 is a plot of phase spectral density for an experimental implementation of a homodyne system with (solid unbroken line) and without (broken, dashed line) offset modulation; and

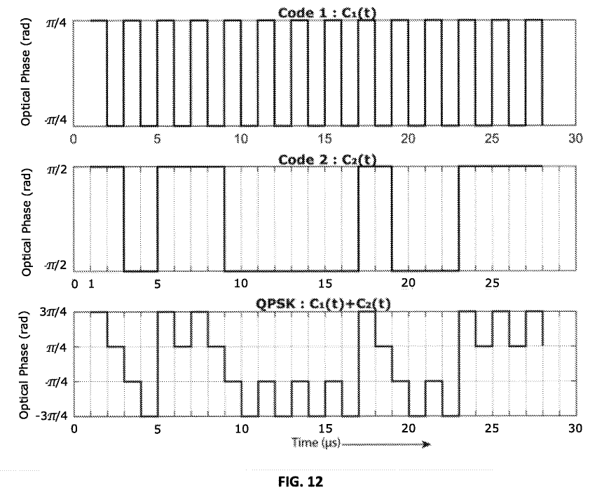

(hh) FIG. 12 is three plots of two sequences being combined to form the first modulation sequence in a homodyne system.

### DETAILED DESCRIPTION

### Overview

Described herein is a system 100 for optical interferometric sensing using digitally enhanced interferometry (DI). In digitally enhanced interferometry (DI), the correlation properties of a pseudo-random noise (PRN) sequence (also written as “pseudorandom noise sequence”) are used to enable time-of-flight based ranging and selective recovery of an optical signal of interest. Of interest are: the correlation value at delays other than the signal-of-interest, which represent the amount of coherent coupling of spurious noise; and/or the arctangent operation that recovers phase information from the detected optical signal.

The system 100 may be configured for offset demodulation, described hereinafter, hence may be described as an Offset Demodulation System. The system 100 may be configured for offset modulation, described hereinafter, hence may be described as an Offset Modulation System. In the Offset Demodulation System, an interference signal from an interferometer with a digital modulation is demodulated using a selected linear combination and a selected pair of offset digital sequences, implemented using two parallel demodulation/decoding channels for the respective digital sequences, or using a single decoding channel for the linear combination of the digital sequences (the combination being referred to as a “single compound digital sequence”). In the Offset Modulation System, an interference signal from an interferometer is modulated using a selected linear combination and a selected pair of offset digital sequences, implemented using two parallel modulation/encoding channels (e.g. a pair of modulators, or a modulator and a delay) for the respective digital sequences, or using a single modulation/encoding channel (e.g. a modulator) for the linear combination of the digital sequences (the combination being referred to as a “single compound digital sequence”).

### Digitally Enhanced Interferometry (DI) System

As shown in FIGS. 1A, 1B, 1C and 1D (for different respective interferometer configurations), the system 100 includes:
(a) an optical source 102 configured to provide at least one first optical beam and at least one second optical beam (both of which propagate as electromagnetic waves in free space and/or in a medium such as an optical fibre);
(b) an interferometer 101 including:
   i. at least one first optical path for the (at least one) first optical beam (e.g., one or more signal beams),
   ii. at least one second optical path for the (at least one) second optical beam (e.g., one or more reference beams when the first optical beam includes the signal beams),
   iii. a modulator configured to modulate the first optical beam and/or the second optical beam based on a first modulation signal from a signal generator 110 representing a digital modulation sequence from a sequence source 112 (e.g., including a pseudo-random number generator with the digital modulation sequence selected as described hereinafter), and
   iv. an optical combiner/detector configured to detect interference fringes between the first and second optical beams after the first and second optical beams have traversed the first and second optical paths and been modulated (i.e., at least the first and/or the second optical beams has been modulated); and
(c) an electronic processing system 118 including:
   a receiver element (“receiver”) configured to receive from the optical combiner/detector an interference signal that is indicative of an interferometer phase, which is an optical phase difference between the first and second optical beams,
   a demodulator configured to obtain/generate at least one decoding output by demodulating the interference signal using at least one digital demodulation sequence that is associated with (e.g., based on, or at least mathematically associated with, as described in further detail hereinafter) the at least one digital modulation sequence, and
   a phase output element configured to determine/generate the interferometer phase based on the at least one decoding output.

As shown in FIGS. 4A to 4D and 9A to 9D, and described in more detail hereinafter, the at least one digital modulation sequence or the at least one digital demodulation sequence is based on a plurality of digital sequences (i.e., is formed from the plurality of digital sequences), which include a first digital sequence 401 and a second digital sequence, wherein the second digital sequence is a time-shifted version of the first digital sequence 401 (by an offset delay To). The combination of the plurality of the digital sequences according to a (selected) linear algebraic operation (#) can be referred to as a “compound digital sequence” 436. The sequence source may be configured to generate the first digital sequence 401, the second digital sequence, and/or the compound digital sequence 436 for the modulation or for the demodulation. The electronic processing system and/or the sequence source may be configured to generate the second digital sequence by time shifting the first modulation sequence by the offset delay To. The second digital sequence can be generated and time-shifted anywhere in the system, not just the decoder. The interferometer 101 applies a signal delay Ts to a signal of interest from the interferometer 101, e.g., a vibration, as shown in FIGS. 4A to 4D.

In the Offset Demodulation System, the at least one digital modulation sequence includes just the first digital sequence 401, and the at least one digital demodulation sequence includes either:
(a) one compound digital demodulation sequence 436 formed of the first digital sequence 401 and the second digital sequence combined according to the selected linear algebraic operation (#); or
(b) two separate demodulation sequences, i.e., including respectively the first digital sequence 401 and the second digital sequence, which are applied separately to demodulate the interference signal to obtain generate a plurality of the at least one decoding output (e.g., two decoding outputs), and the two decoding outputs are combined according to the selected linear algebraic operation (#) to determine/generate the interferometer phase.

In the Offset Modulation System, the at least one digital demodulation sequence includes just the first digital sequence 401, and the at least one digital modulation sequence include either:
(a) one compound digital modulation sequence 436 formed of the first digital sequence 401 and the second digital sequence combined according to the selected linear algebraic operation (#); or
(b) two separate modulation sequences, i.e., including respectively the first digital sequence 401 and the second digital sequence, which are applied separately to modulate the beams (either one beam is modulated by both separate modulation sequences (using modulators in series), or each beam is modulated by a separate one of the modulation sequences (with modulators in parallel), to obtain generate a plurality of the at least one decoding output (e.g., two decoding outputs)—in other words, the first optical beam and/or the second optical beam are modulated (i.e., using a plurality of the least one modulator configured to modulate the first optical beam and/or the second optical beam, e.g., two modulators on one beam, or one modulator on each beam)—and wherein the two beams are modulated and combined according to the selected linear algebraic operation (#) (i.e., combined by modulating one beam according to (#) if the modulators act on the one beam, or optically combined according (#) if the modulators act on separate beams), and the two decoding outputs are combined according to the selected linear algebraic operation (#) to determine/generate the interferometer phase.

In other words, one of the modulation (using the at least one digital modulation sequence) and the demodulation (using the at least one digital demodulation sequence) is based on just the first digital sequence 401, and the other of the modulation and the demodulation is based on both the first digital sequence 401 and the second digital sequence, either combined directly by (#) to form a compound digital sequence 436 or having their respective outputs combined according to (#).

### Interferometer Configurations

As shown in FIGS. 1B, 1C and 1D, the interferometer 101 may include an optical splitter 104 configured to split the light beam from the optical source into the first optical beam and the second optical beam (and in some instances additional optical beams, i.e., at least three or more, e.g., for array interferometry). Alternatively, the optical source 102 may include a first plurality of phase-coherent optical sources that provide the first optical beam, and/or a second plurality of phase-coherent optical sources that provide the second optical beam (and in some instances the additional optical beams).

As shown in FIG. 1B, the interferometer 101 may include a Mach-Zehnder (MZ) interferometer 101A with modulation in one arm, i.e., including a first optical path 106 for the first optical beam, a first modulator 108 configured to modulate the first optical beam in the first optical path based on the first modulation signal, a second optical path 114 for the second optical beam, and an optical combiner/detector 116 configured to combine the first and second optical beams and detect (i.e., detect the interference fringes) the first and second optical beams after the first and second optical beams have traversed the first and second optical paths.

As shown in FIG. 1C, the interferometer 101 may include a MZ interferometer 101B with common modulation of both arms (i.e., the same modulation applied to both arms) and a time delay in one arm (due to a physical arm length difference between the two arms). This interferometer 101B includes time delay element (delta) 120 provided by an optical length difference (e.g., a length of optical fibre) between the two arms 114,106 (i.e., the first optical path and the second optical path), thus providing different travel times (physical lengths) for the two signal arms (thus first optical beam and the second optical beam). The interferometer 101B includes the modulator 108 arranged and configured to modulate both the first optical beam and the second optical beam before they are split by the splitter 104, thus requiring a decoding cascade as described hereinafter.

As shown in FIG. 1D, the interferometer 101 may include a MZ interferometer 101C with modulation in both arms, i.e., a first modulator 108A (arranged and configured to modulate the first optical beam) driven by a first signal generator 110A, and a second modulator 108B (arranged and configured to modulate the second optical beam) driven by a second signal generator 110B. The interferometer 101C encodes the detected interference fringes in two cascaded codes that require a decoding cascade as described hereinafter.

As shown in FIG. 1E, the interferometer 101 may include a Sagnac interferometer with two modulators 108A,108B that both modulate both of the first and second optical beams, which are combined in a splitter/combiner 104A, and a time delay element (delta) 120 in the optical path between the two modulators 108A,108B.

Having the pair of optical beams modulated more than once, e.g., as in FIGS. 1C, 1D and 1E, means each interference signal has been encoded twice or more, and thus the electronic processing system 118 is configured to decode the interference signal twice or more: this is referred to as “cascaded decoding” and is described in more detail hereinafter with reference to FIG. 15 (e.g., the interferometer in FIG. 1C modulates each beam once but still needs cascaded decoding).

### Processing System

Following detection by the optical combiner/detector 116, the interference signal is digitised in the processing system 118. The encoding on the first optical beam is recovered by the demodulating, which includes a cross-correlation against one or more delay-matched (i.e., to the signal delay Ts) digital demodulation codes as described hereinafter, including with reference to FIGS. 4A-D and 9A-D. The phase information from the recovered interference signal may be transformed from rectilinear coordinates using an arctangent operation which may be computed in real-time, as described hereinafter. The processing system 118 may include at least one field-programmable gate array (FPGA) or an equivalent high-speed digital signal processing module configured to perform the operations of the processing system 118 in real time; alternatively, in some embodiments, one or more of the operations of the processing system 118 may be performed at a later time, in post processing, e.g., using a general-purpose computing system rather than the FPGA. The interferometer phase represents an amount of time difference between the first beam traversing the first optical path and the second beam traversing the second optical path. For a system with one signal of interest, the processing system 118 determines the interferometer phase between the first and second optical beams using I and Q recovered from the peak of the cross-correlation. For a system or implementation with a plurality of signals of interest, the processing system determines a respective plurality of interferometer phases from a respective plurality of peaks of the cross-correlations. The signal of interest determines which correlation peak to use for phase extraction/recovery. The interferometer phase may be described as Delta(phi_(ij))=phi_(i)−phi_(j) and i and j are the two interferometer paths of interest, i.e., the at least one first optical path and the at least one second optical path.

As described in further detail hereinafter, to perform offset modulation or offset demodulation, the first digital sequence 401 is configured/adapted/selected to have an autocorrelation such that the linear combination (#) of two time-shifted versions of the autocorrelation substantially equal zero for delays excluding the signal delay (Ts). The system 100 utilises this autocorrelation linear combination (#) to cancel out residual correlation and/or crosstalk seen by the demodulating. In general, the optical phase in the interference signal provides microscopic/precision measurement, and the digital modulation and demodulation provides isolation, gating and selectivity at the macroscopic (m/cm) scale. The optimum signal delay Ts refers to the time-of-flight/range to the location of the signal of interest within the interferometer 101. For example, if detecting a vibration signal from a reflection at the end of a 1 km fibre, the delay will be substantially equal to the delay in transiting the 1 km round trip with the vibration itself is measured by tracking the change in optical phase of that signal; if there is another partial reflection (and accompanying vibration) say 500 m away, this has a substantial difference in delay, and therefore its optical phase signal is rejected due to the selectivity of the digital offset modulation or demodulation. The digital signal delay (e.g., T1 in FIGS. 4A to 4D) is selected by a person or automatically, depending on the configuration of the interferometer and the application, to be substantially equal to the optimum signal delay Ts, e.g., equal to Ts or +/−0.5 code symbols from the optimum signal delay if the selected linear combination is a summation because both the first decoding output and the second decoding output can carry a portion of the signal of interest, e.g., as shown in FIG. 2A(a). The decoding operation does not fundamentally depend on delay T1,T2, but the only useful case is when the first delay T1 or the second delay T2, e.g., in FIGS. 4A to 4D and 9A to 9D, substantially equals the signal delay Ts, i.e., so the signal is represented in the interferometer phase. With reference to FIGS. 4A-4D and 9A-9D, the signal delay Ts in the interferometer includes any optical and digital components between the modulator and the demodulator, the first delay T1 is the selected delay applied to the demodulator to extract the signal, i.e., the first delay T1 is selected to substantially match the signal delay Ts. The second delay T2 is the selected offset delay To—which may be between the first digital sequence and the second digital sequence to form the compound sequence (for demodulation in FIGS. 4B and 9B, or for modulation in FIGS. 4C and 9C), between the first optical modulation and the second optical modulation (FIGS. 4D and 9D), or between the first decoding operation and the second decoding operations (FIGS. 4A and 9A).

The processing system 118 outputs/transmits signals representing the interferometer phase for the purpose of the optical interferometric sensing, e.g., to different downstream systems depending on applications.

The sequence source 112 includes and provides at least the first digital sequence 401, and in embodiments both the first and second digital sequences and/or the compound digital sequence, and/or a deterministic, predicable periodic sequence 901 in homodyne implementations. As described in more detail hereinafter, the first digital sequence 401 has an autocorrelation profile that determines the selection of the offset delay To. In embodiments, the sequence source 112 may include a linear feedback shift register on the FPGA or a digital signal processing (DSP) module (e.g., a hardware module), which may be available as an output mode from a signal generator (commercially available), which may be incorporated with the signal generator 110, or in a separate computing system, or entirely on an FPGA.

### Digital Sequences

As shown in FIGS. 2A(a) and 2A(b), in some embodiments using an A1-sequence (described in further detail hereinafter) as the first digital sequence 401, the second digital sequence may be offset from the first digital sequence (e.g., by To=1) such that the correlation amplitudes of the first and second digital sequences have complementary oscillations. Thus, as shown in FIGS. 2A(c) and 2A(d), the respective one or more decoding outputs recover a full correlation peak for the signal of interest (at a delay of 0 and 1), with a factor of two increase in width, while suppressing crosstalk at all other delays (as shown in FIG. 2A(d)).

As shown in FIG. 2B(a), for a first digital sequence in the form of an M-sequence (described in further detail hereinafter), the linear combination (#) (in the form of a subtraction) of the first correlation (between a time-domain interference signal and the first digital sequence) and the second correlation (between the time-domain interference signal and the second digital sequence that is an offset version—i.e., a time-delayed version—of the first digital sequence 401, e.g., offset by minus one code symbol—i.e., having a relative offset of minus one code symbol) recovers the signal while suppressing crosstalk at all other delays, as shown in FIG. 2B(b).

The type of the first modulation sequence may be: an M-sequence, an A1-sequence, or an A2 sequence (described in further detail hereinafter). The value of the offset delay To is selected by a designer or operator of the system 100, or automatically depending on the application and type of interferometer, based on the type of the first digital sequence and its autocorrelation. The offset delay To may be selected to be anywhere in the code space defined by the first digital sequence, i.e., the minimum offset can be by one symbol (“chip”), and the maximum can be the length of the first digital sequence. The form of the linear combination operation (#) is selected based on the form of the first digital sequence and the selected offset delay To, e.g., as described hereinafter. The combination operation (#) is an algebraic operation that uses two input values (“x” and “y”), wherein the two values are based on simultaneous measurements in the interferometer 101, so the combination operation (#) can be fast, in real time. The combination operation (#) is linear, so may be expressed as “Ax+By”, where x and y are values from the first decoding output and the second decoding output, and A and B are constants and real values (positive or negative) that are selected to zero out when there is no signal (which depends on the type of the first digital sequence 401 selected). Furthermore, there is no physical noise introduced between the two values because they are from the same simultaneous measurement in the interferometer 101. The one or more modulations or demodulations (e.g., to generate modulated beam(s) and the decoding output(s)) occur simultaneously, whereas the codes used to demodulate each of these signal chains are delayed relative to each other, e.g., delay 1 is decoding modulation symbol 1, 2, 3 while delay 2 is decoding symbols 2, 3, 4 over that same time span.

### Heterodyne or Homodyne Configurations

As explained in further detail below, the system 100 may be configured for: digitally-enhanced heterodyne interferometry (DEHeI), thus forming a “heterodyne system”; or digitally-enhanced homodyne interferometry (DEHoI), thus forming a “homodyne system”. As described in more detail hereinafter, in the homodyne system, the digital modulation sequence from the first signal generator 110 represents two phase-orthogonal modulation signals: (a) the first digital sequence 401; and (b) a deterministic, predictable, repetitive, periodic sequence 901 that provides a phase modulation, which alternates between quadratures in a complex plane (i.e., the “IQ” plane), e.g., such that the first modulation signal (on the first optical beam) equally samples both orthogonal quadratures of the IQ plane.

### Applications

The system 100 provides spurious noise cancellation and/or residual crosstalk suppression through algebraic cancellation at delays away from the signal of interest, e.g., complete suppression of spurious noise outside of the measurement delay of interest (in both DEHeI and DEHoI with offset modulation or offset demodulation, using a compound digital sequence or separate digital sequences in parallel modulation/demodulation). The use of the offset modulation/demodulation to generate zero-correlation at non-signal delays relies on the correlation profile of the digital sequences.

The offset modulation/demodulation described herein may address a limit of noise suppression in previous DI systems that typically use M-sequences and do not use an offset delay: in such systems, the demodulation (which also uses correlation) generates a peak value to recover the amplitude of the decoded delay. Using M-sequences in previous DI systems, the peak value is amplified (i.e., multiplied) by the code length, L, whereas signals from all other delays (i.e., the non-signal delays) contribute crosstalk amplified (i.e., scaled by the correlation, or “decoding gain”) by −1, thus yielding a nominal 1/L suppression of the crosstalk (representing noise) relative to the peak value (representing the signal). In previous DEHeI systems, cross-talk suppression between code delayed signals may be limited to 1/L, where “L” is the sequence length, giving poor rejection of spurious signals/noise: such cross-talk can limit achievable sensitivity and/or number of useful multiplexing channels in an interferometer, and using longer code lengths (L) reduces available single bandwidth. The offset modulation/demodulation described herein provides cancellation of the crosstalk measurement from the demodulated (or “decoded”) signal of interest. The offset modulation/demodulation algebraically cancels residual crosstalk from the desired measurement, thus potentially significantly exceeding the 1/L M-sequence crosstalk noise limit. The offset modulation/demodulation described herein may surpass previous methods/processes for suppression of spectrally broad noise in DI systems (for both DEHeI systems and DEHoI systems) with no change to code length, and therefore may maintain the same measurement rate (bandwidth) and duty cycle as previous systems (e.g., based on M-sequences). The offset modulation/demodulation described herein allows for the isolation of specific optical interferometric signals from a complex interferometric system with substantially suppressed crosstalk.

### Digital Sequences—Details

The first digital sequence 401 and the second digital sequence are each formed of digital, i.e., discrete-time signals representing values. The first digital sequence 401 includes a sequence of symbols, also referred to “code elements” or “chips”, and each symbol is one of a finite set of symbols (e.g. high and low, or “1”s and “0”s). The first digital sequence 401 is formed of random codes (referred to as “pseudo-random codes” or “pseudo-random noise (PRN) codes”), or other types of codes having similar correlation and orthogonality properties to PRN codes; accordingly, the first digital sequence 401 may be referred to as a “PRN sequence”. The first digital sequence 401 may include a four-level code (i.e., the first digital sequence 401 may be constructed from the sum of a sequence of PRN codes and corresponding sequence of square-wave values, e.g., as shown in FIG. 12), in which each code symbol may take on any one of four states/values.

The first digital sequence 401 is a digital sequence of any appropriate type, e.g., an M-sequence, an A1-sequence or an A2-sequence. The first digital sequence 401 is a pseudo-random bit stream. The at least one digital modulation sequence and the corresponding at least one digital demodulation sequence both have a symbol rate (or digital “chip frequency”), e.g., that is at least 10 Hz. The chip frequency (also known as the “modulation rate” or “digital modulation rate”) may be between 1 kHz and 1 THz, e.g., 10 kHz to 10 GHz. A temporal resolution of the digital modulation sequence and corresponding digital demodulation sequence may be used to impose or modify correlation conditions, selected based on the application, and may be determined by the chip frequency.

The first digital sequence 401 (and thus the second digital sequence) includes three or more pseudo-randomly selected/generated symbols (“elements”), e.g., around 30 or 31 elements in some examples. The first digital sequence 401 (and thus the second digital sequence) includes a total number of symbols/elements that define a length (“physical sequence length”, i.e., the physical space/length occupied by the code sequence in an optical system) of the bit stream. The physical sequence length of the bit stream is controlled by the total number of symbols (code length) and the symbol rate/chip frequency, and the speed of the optical beam in the interferometer 101. The physical sequence length may be selected to be: at least as large as a selected range of distance measurements being made by the interferometer 101 (e.g., in a ranging application); and at least substantially equal to the larger of the optical paths in the interferometer 101, e.g., of the first optical path 106 or the second optical path 114 (e.g., to reduce optical scatter from more than one instance of the code in the interferometer 101). The sequence length and the symbol rate may be selected based on a predetermined required bandwidth of the interferometer 101 (because the processing system 118 integrates over the length of the digital modulation sequence to detect the interferometer phase). The range detectable by the system 100, e.g., in an interferometric ranging application, may be controlled by the physical sequence length of the first modulation sequence (i.e., sequence length defined by the number of the symbols therein), wherein increasing the length can increase the maximum ranging distance (ambiguity range).

The first digital sequence 401 may include: (a) PRN sequences including and equivalent to maximum length sequences (MLS), also known as “M-sequences” or “n-sequences”; and/or (b) second-order sequences generated using linear operations on PRN sequences, including “A1-sequences” and “A2-sequences” and equivalents. The second-order sequences (e.g., A1- and A2-sequences) may be generated from the PRN sequences (e.g., M-sequences), e.g., an M-sequence as described in a publication by Daniel A. Shaddock, “Digitally enhanced heterodyne interferometry,” Opt. Lett. 32, 3355-3357 (2007).

For the A1-sequences and A2-sequences, the offset modulation/demodulation methods/processes and systems described herein utilise the oscillatory nature of the correlation profile of the first sequence (e.g., A-sequence) to cancel out residual correlation seen by the interferometer by carrying out the modulation/demodulation process at the two delays. For example, in the Heterodyne System with Offset Demodulation using Two Parallel Demodulation/Decoding Channels (described hereinafter with reference to FIG. 4A): the first delay (T1) to recover the first decoding output (including the delay of the signal of interest (Ts)), and the second delay (T1+/−T2), which is offset (by To), to recover the second decoding output with which to cancel out the spurious signals from the first decoding output. When the two demodulated outputs (i.e., first decoding output and the second decoding output) are linearly combined (e.g., summed), the processing system 118 recovers the full correlation peak at substantially the delay of the signal of interest Ts (and at a delay shifted by the offset To, so slightly broader than in the first decoding output), whereas at delays away from the delay of the signal of interest, the first decoding output and the second decoding output (which are correlations or “correlation profiles”) are substantially out of phase (e.g., by 180 degrees) when linearly combined, so the combination by (#) (e.g., summation) coerces the spurious noise algebraically to substantially zero, suppressing the noise from the readout and significantly reducing the crosstalk. For A1-sequences and A2-sequences, the first modulation sequence has (i.e., is characterised by) an autocorrelation profile (also referred to as an “autocorrelation” or “autocorrelation output”) with a periodic variation in values between its peak and its end, e.g., as shown in FIG. 2A. The periodic variation in the autocorrelation profile values has a half-period substantially equal to, or equal to, the offset delay To (e.g., 1 chip). Due to this periodic variation, the autocorrelation profile of the first modulation sequence may be described as “oscillatory”.

For the A1-sequences and A2-sequences, the first digital sequence 401 has (i.e., is characterised by) an autocorrelation profile (also referred to as an “autocorrelation” or “autocorrelation output”) with a periodic variation between its peak value and the residual value (e.g., −1 for M), while the period is equal to the code length. A1-sequences and A2-sequences are described in a publication by Yves Emery and Cristina Flesia, “Use of the A1- and the A2-sequences to modulate continuous-wave pseudorandom noise LIDAR,” Appl. Opt. 37, 2238-2241 (1998). For example, as shown in FIG. 3(a), the autocorrelation profile (phi) of a bipolar A1-sequence has a strong autocorrelation (equal to the code length of 14 in FIG. 3(a)) at half code length where there is a negative peak, and the other peaks have a periodic variation in values, alternating between +2 and −2.

In another example, as shown in FIG. 3(b), the autocorrelation profile (phi) of an M-sequence has a peak which recovers the amplitude of the decoded delay multiplied by the code length, L, and signals from all other delays contribute cross-talk at a level of −1, which yields a nominal 1/L suppression. The offset decoding anti-correlates the cross-talk by carrying out the second (‘offset’) decoding operation for a delay that is not utilised in the physical system, i.e., the offset delay To may be selected to represent a distance equal to or larger than the at least one first optical path and at least one second optical path (i.e., the optical paths in the interferometer), e.g., for a code length of 15 symbols, if an optical system occupies 14 symbols for a given modulation rate (chip frequency), the remaining unused delay is used for offset modulation/demodulation (as there is no physical signal present, this is solely a measurement of the cross-talk from other code delays).

As described hereinbefore, for an A1-sequence, the offset delay To may be selected to be substantially equal to the half-period of the periodic variation in the residual autocorrelation value, e.g., the A1 period is 2 chip in length, and the To can be selected to be 1 or −1. The offset delay To is thus defined or selected by properties of the first digital sequence. For an A1 sequence, the form of the linear combination operation (i.e., (#) including the selected values of “A” and “B” in the relationship “Ax+By”) depends on the selected To as follows: where k is an integer number, representing the number of chips offset, which is equal to or between L (length of the first sequence) and zero for the A1-sequence, the offset delay To can be: 2k+1 symbols, which requires the linear algebraic operations (#) is a summation, e.g., the first decoding output and the second decoding output are summed to obtain the interferometer phase; or 2k+2 symbols, which requires the linear algebraic operations (#) is a subtraction, e.g., the first decoding output and the second decoding output are differenced to obtain the interferometer phase; or ½ a symbol, which requires the first delay T1 to be +/−½ a symbol from the optimal signal delay Ts (and T2=−/+½), and the linear algebraic operation (#) is a summation, e.g., the first decoding output and the second decoding output are summed to obtain the interferometer phase. In another example for the A2-sequence, the offset delay To can be: 4k+2 symbols, which requires the linear algebraic operation (#) to be a summation, e.g., the first decoding output and the second decoding output to be summed to obtain the interferometer phase; or 4k+4 symbols, which requires the linear algebraic operation (#) to be a subtraction, e.g., the first decoding output and the second decoding output are differenced to obtain the interferometer phase.

For the first digital sequence 401 in the form of an M-sequence, the offset delay To can be selected to be any value between 1 and L−1 that allows the linear algebraic operation (#) to be a subtraction, e.g., such that the first decoding output and the second decoding output are differenced to obtain the interferometer phase. For an M-sequence, the offset delay To may be selected to be substantially equal to any delay not occupied by a physical signal (neither signal of interest nor a spurious signal), which means that the offset delay To, for an M-sequence, is dependent on the sequence length L, and the proportion of the sequence length (also referred to as delay space) unoccupied by the physical signals (when the physical sequence length is greater than the interferometer length). This ensures there is no physical signal present and therefore only this is solely a measurement of the crosstalk from other code delays. The code length may be selected to be greater than or equal to the optical path lengths in the interferometer.

For offset modulation or demodulation (with any sequence), the offset delay can be in part of the delay space that is not used by the physical system (i.e., has no physical signals present), which gives a measurement of the correlation at all unwanted delays with no second signal, therefore the output removes the residual from all delays, retains the first signal and does not introduce a second contaminating signal. In other words, the offset delay is selected, for any sequence, to correspond to a delay not already associated with/occupied by a physical signal in the interferometer, including an functioning interferometer channel signal and/or a spurious signal. By selecting an offset delay that is non-physical, e.g., a delay less than the time of flight through the shortest optical path, the offset decoding operation can avoid contributing additional noise.

Heterodyne System with Offset Demodulation Using Parallel Demodulation/Decoding Channels

The system 100 configured for Digitally-Enhanced Heterodyne Interferometry (DEHeI) (“heterodyne system”) further may include a heterodyne modulator in the first optical path or in the second optical path that is configured to frequency shift (i.e., shift the frequency) the first and/or second optical beam at a heterodyne frequency (fh) generated by a heterodyne signal generator.

As shown in FIG. 4A, the heterodyne system with offset demodulation using parallel demodulation/decoding channels (“system 400A”) includes:
a sequence stage 402 that includes at least the sequence source 112 which provides at least the first digital sequence 401 (e.g., an M-sequence or an A1/A2-sequence);
a modulation stage 404 that includes an optical system 414 with the interferometer 101, which includes the optical modulator(s) 108,108A,108B (“Mod”) that provide(s) the signal delay Ts, and which is connected to the sequence stage 402 to receive the first digital sequence 401;
an offset demodulation stage 406A that is connected to the modulation stage 404 with the receiver to receive the interference signal from the interferometer 101, and connected to the sequence stage 402 to receive the first digital sequence 401, which includes the selected/tuned first delay T1 applied to the first digital sequence 401 and the selected/tuned second delay T2 (selected to be To), and two parallel demodulators 416A1,416A2 that receive and demodulate the interference signal using the first digital sequence 401 (to generate a first decoding output 418A 1 “RF-signal”) and using the second digital sequence (to generate a second decoding output 418A2 “RF-offset”);
a correlation reconstruction stage 408A that is connected to the offset demodulation stage 406A to receive the first decoding output 418A1 and the second decoding output 418A2, and that includes a linear algebraic module 420 configured to perform the selected linear algebraic operation (#) on the plurality of decoding outputs 418A1, 418A2 to form a (final, combined) decoding output 422, i.e., an output from the correlation reconstruction stage 408A;
a heterodyne mixdown stage 410 that is connected to the correlation reconstruction stage 408A to receive the final, combined decoding output 422, and that includes:
   two parallel heterodyne demodulators 424,426) configured to mix down the final, combined decoding output 422 by the heterodyne frequency (fh) both in phase (cosine) and in quadrature (sine, i.e., with a 90-degree phase shift between the heterodyne demodulators 424,426), and configured to generate respective mixed-down heterodyne signals 425,427, and
   two parallel low pass filters 428,430, which are code filters defined by the first digital sequence configured to compute the autocorrelation of each channel (with a kernel length equal to the length of the first digital sequence 401), and which operate to remove second harmonics from the respective mixed-down heterodyne signals 425,427, that generate an in-phase baseband signal 432I and a quadrature baseband signal 432Q respectively; and
a phase recovery stage 412 that is connected to the heterodyne mixdown stage 410 to receive the in-phase baseband signal 432I and the quadrature baseband signal 432Q, and that includes a phase-unwrap module 434 that is configured to determine/generate/recover the interferometer phase (i.e., optical phase measurement) from a combination of the in-phase baseband signal 432I and the quadrature baseband signal 432Q, e.g., using an arctan operation.

The low pass filters 428,430 act as integrators to compute the respective baseband signals 432Q,432I. Together with the first demodulator 416A1 and the second demodulator 416A2, the low pass filters 428,430 compute the cross correlation of the signals received by the first demodulator 416A1 and the second demodulator 416A2.

The electronic processing system 118 in the heterodyne system (“heterodyne processing system”) includes the offset demodulation stage 406A, the correlation reconstruction stage 408A, the heterodyne mixdown stage 410 and the phase recovery stage 412. The offset demodulation stage 406A, the correlation reconstruction stage 408A, the heterodyne mixdown stage 410 and the phase recovery stage 412 may be referred to as a “signal decoding chain”. The heterodyne mixdown stage 410 and the phase recovery stage 412 form the phase output element that generates the interferometer phase from the decoding output.

In alternative embodiments, the system 100 could be configured to include the heterodyne demodulation operation (performed by the heterodyne demodulators 424,426) prior to the correlation reconstruction operation (performed by the linear algebraic module 420).

The demodulation by the first demodulator 416A1, with the first delay T1 substantially equal to the signal delay Ts, recovers the signal and spurious crosstalk in the first decoding output 418A1. The demodulation by the second demodulator 416A2, with the second delay T2 substantially equal to the offset delay To and thus substantially not equal to the signal delay Ts, recovers the same spurious crosstalk seen in the first demodulation, but due to the correlation profile of the first digital sequence, the second decoding output 418A2 is delay-shifted and may be inverted (for some types of the first digital sequence 401) in a linear manner relative to the first decoding output 418A1. Due to this anti-correlation of the crosstalk, when the linear algebraic combination (e.g., sum) of the two demodulation channels is taken to form the combined decoding output 422, the heterodyne processing system recovers the signal at the signal delay while cancelling out the crosstalk at other delays. For an example with the linear algebraic operation (#) being a summation and using the A1 sequence, and the offset To being 1 symbol, spurious noise at the two demodulation channel outputs 418A1,418A2 can be equal in amplitude and substantially 180 degrees out of phase. Thus, whilst each individual channel output 418A1,418A2 can have a non-zero spurious noise, with matched amplitudes and 180 degrees out of phase, the summed output can algebraically cancel out all spurious noise terms that are time delay offset by more than one code symbol with respect to the desired signal delay.

In an example experimental implementation, shown in FIG. 5, an example of the heterodyne system was configured to demonstrate/quantify spurious noise and crosstalk suppression by having two of the first optical path and two of the first modulator (“AOM”) operating at the same (RF) modulation frequency (e.g., 39 MHz) with different first sequences (encoding different signals, i.e., “signal 1”, which was a 220 Hz waveform, and “signal 2”, which was a 185 Hz waveform) defined by the same first bit stream (“PRN code”) with two mutually different delays (“T_s1” and “T_s2”). In the system of FIG. 5, the two first optical paths were referred to as “signal arms” and the second optical path was referred to as a “reference arm” or “local oscillator arm”. Each signal arm had a modulator in the form of an AOM that was operated at 39 MHz and modulated with a PRN code: either a 31 chip M-sequence or a 30 chip A1-sequence, while the code delay in each arm (T_s1 and T_s2 respectively) was adjusted during the experiment. In addition, a sinusoidal signal was injected into each arm via the relevant AOM: channel one at 220 Hz (“signal 1”) and channel two at 185 Hz (“signal 2”). The reference arm AOM was driven by a simple unmodulated sinusoid at 40 MHz so that a heterodyne beat was generated at 1 MHz (referred to as the “heterodyne frequency”, “f_h”, =40-39=1 MHz) for each of the signal arms. As shown in FIG. 6(a) for the M-sequence experiment, the undesirable signal measurement (i.e., the crosstalk) was suppressed by substantially 30 dB, which agreed with the predicted code suppression of 1/(code length)= 1/31=substantially 30.4 dB. For the offset demodulation experiment with the A1-sequence, the first delay T1 was fractionally shifted from the signal delay Ts, e.g., Ts+/−½ symbols (T2 was set to delay of 1 with respect to T1), and the first decoding output and the second decoding output were summed to obtain the interferometer phase (i.e., using of the implementations for the A1-sequence described hereinbefore). (In other demodulation experiments with M-sequences the offset delay To was selected to be −1, and the first delay was selected/tuned to be substantially equal to the signal delay (T1=Ts), and the first decoding output and the second decoding output were subtracted to obtain the interferometer phase.) As shown in FIG. 6(b), when demodulating for the PRN delay of signal 1 at 185 Hz, and when demodulating for the PRN delay of signal 2 at 220 Hz, the undesirable trace was suppressed by more than 70 dB, potentially limited only by the noise floor of the experiment. As shown in FIGS. 6(a) and 6(b), the output interferometer phase measurements with the offset demodulation (in FIG. 6(b)) had less signal width spreading (around the signal frequency) than the output interferometer phase measurements without the offset demodulation (in FIG. 6(a)), due to the spurious signal suppression during the offset demodulation processing.

Heterodyne System with Offset Demodulation Using a Compound Digital Sequence

As shown in FIG. 4B, the heterodyne system with offset demodulation using parallel demodulation/decoding channels (“system 400B”) includes:
the sequence stage 402 of the system 400A;
the modulation stage 404 of the system 400A;
a correlation construction stage 408B that is connected to the sequence stage 402 to receive the first digital sequence 401, and that includes:
   the first delay T1 that is tuned/selected to be substantially equal to the signal delay Ts or the signal delay Ts−0.5 symbols (for an A1 sequence and an A2 sequence but not for an M sequence),
   the second delay T2 that is tuned/selected to be substantially equal to the offset delay To, and not equal to 0, and
   the linear algebraic module 420 connected to receive (i) the first digital sequence 401 delayed by the first delay T1 and (ii) the first digital sequence 401 delayed by the first delay T1 and the second delay T2, and configured to provide/generate the compound digital sequence 436;
an offset demodulation stage 406B that is connected to the modulation stage 404 with the receiver to receive the interference signal from the interferometer 101, and that is connected to the correlation reconstruction stage 408B to receive the compound digital sequence, and that includes a demodulator 416B configured to demodulate the interference signal using the compound digital sequence 436 to form a (final) decoding output 422;
the heterodyne mixdown stage 410 of the system 400A, connected to the offset demodulation stage 406B to receive the (final) decoding output 422; and
the phase recovery stage 412 of the system 400A.

Together with the demodulator 416B, the low pass filters 428,430 compute the cross correlation of the signals received by the demodulator 416B.

Heterodyne System with Offset Modulation Using a Compound Digital Sequence

As shown in FIG. 4C, the heterodyne system with offset modulation using a compound digital sequence (“system 400C”) includes:
the sequence stage 402 of the system 400A;
a correlation construction stage 408C that is connected to the sequence stage 402 to receive the first digital sequence 401, and that includes:
   the second delay T2 that is tuned/selected to be substantially equal to the offset delay To, and not equal to 0, and
   the linear algebraic module 420 connected to receive (i) the first digital sequence 401 and (ii) the first digital sequence 401 the second delay T2, and configured to provide/generate the compound digital sequence 436;
an offset modulation stage 438 that is connected to the correlation construction stage 408C to receive the compound digital sequence 436, and that includes the optical system 414 in which the modulator(s) (“Mod”) is/are modulated using the compound digital sequence 436;
a demodulation stage 406C that is connected to the offset modulation stage 438 with the receiver to receive the interference signal from the interferometer 101, and that is connected to the sequence stage 402 to receive the first digital signal 401, and that includes:
   the first signal delay T1 to delay first digital sequence 401 by substantially the signal delay Ts; and
   a demodulator 416C configured to demodulate the (compound encoded) interference signal using the delayed (by T1) first digital sequence 401 to form a (final) decoding output 422;
the heterodyne mixdown stage 410 of system 400A, connected to the demodulation stage 406C to receive the (final) decoding output 422; and
the phase recovery stage 412 of system 400A.

Together with the demodulator 416C, the low pass filters 428,430 compute the cross correlation of the signals received by the demodulator 416C.

Heterodyne System with Offset Modulation Using Parallel Modulation/Encoding Channels

As shown in FIG. 4D, the heterodyne system with offset modulation using parallel modulation/encoding channels (“system 400D”) includes:
the sequence stage 402 of the system 400A;
an offset modulation stage 440 that is connected to the sequence stage 402 to receive the first digital sequence 401, and that includes:
   the second delay T2 that is tuned/selected to delay the first digital sequence 401 substantially by To, or to delay one of the modulated beams by To (e.g., using an optical delay component tuned to To), and
   a first portion of the optical system 414 in which the plurality of the modulators (“Mod”) generated one or more of the beams modulated by: (i) the first digital sequence 401 and simultaneously (ii) the delayed first digital sequence 401;
a correlation reconstruction stage 408D that includes:
   a second portion of the optical system 414, including an optical combiner 442 to perform the selected linear algebraic operation (#) on the one or more of modulated beams, i.e., by modulating one beam according to the selected linear algebraic operation (#) if both modulators (Mod) act on the one beam, or optically combining the modulated beams according to the selected linear algebraic operation (#) if the modulators (Mod) act on separate beams, and
   notionally the signal delay Ts, although the signal delay is provided by all portions of the system between the modulators and the demodulator 416D;
a demodulation stage 406D, with the same configuration as the demodulation stage 406C of the system 400C, that is connected to the correlation reconstruction stage 408D to receive the interference signal from the interferometer 101, and that is connected to the sequence stage 402 to receive the first digital signal 401;
the heterodyne mixdown stage 410 of system 400A, connected to the demodulation stage 406C to receive the (final) decoding output 422; and
the phase recovery stage 412 of system 400A.

Together with the demodulator 416D, the low pass filters 428,430 compute the cross correlation of the signals received by the demodulator 416D.

### Homodyne Systems

The system 100 configured for Digitally-Enhanced Homodyne Interferometry (DEHoI)(“homodyne system”) does not require the second modulator 108 configured to modulate the second optical beam in the second optical path at the heterodyne frequency (fh) as in the heterodyne system, thus some implementations of the optical system may be simpler in the homodyne system. Compared to digitally-enhanced heterodyne interferometry (DEHeI) systems, DEHoI systems do not require a frequency-shifted local oscillator to scan the phase of the signal beam (also referred to as a “signal field”), making them compatible with single-frequency interferometers including Sagnac interferometers used for rotation sensing applications, of which system 100 is an example. Moreover, by removing the need for a frequency-shifted local oscillator, DEHoI architectures normally necessitate fewer hardware components than equivalent heterodyne-based architectures, enabling, in some examples, the construction of optically simpler, more compact, and cheaper systems.

Optical detection in the homodyne system is achieved by encoding an optical carrier, for example, with a four-level pseudo-random code which encodes the carrier phase at four discrete points in IQ (in-phase, quadrature) space, such as a QPSK code. As with DEHeI, the homodyne variant also allows for gating of signals based on code time-of-flight while retaining the full interferometric readout. This enables the same suite of improvements afforded by DEHeI, including a multiplexed readout from several in-line sensors, rejection of spurious electric fields due to scattering, and extraction of coarse-ranging information.

In the homodyne system, a modulated pseudo-random digital sequence (“homodyne digital sequence 903”) is used instead of just the first digital sequence 401, and the homodyne digital sequence (which is formed of the first digital sequence 401 and a periodic sequence 901) is selected such that (“the three properties”):
(1) the first digital sequence 401 modulates the interferometer phase with a peak-to-peak modulation depth of pi radians;
(2) the homodyne digital sequence 903 modulates both quadratures (I & Q) equally such that the autocorrelation properties of the first digital sequence 401 are independently preserved in both the I and Q readouts; thus, for every pseudo-random code symbol in the first digital sequence, an additional predictable, repetitive/periodic, deterministic (non-random) phase modulation (“regular modulation” or “IQ modulation”) is provided by combining the first digital sequence 401 with the periodic sequence 901 to sample both quadratures—the periodic sequence 901 (e.g., a square wave) is selected such that the full cycle period, or an integer number of periods of the periodic sequence 901, is synchronous with the symbol (chip) frequency of the first digital sequence 401, which requirement results in the following condition: f_(IQ)=m f_c, where f_(IQ) is the frequency of the periodic sequence 901, m is any positive integer, and f_c is the symbol (chip) frequency of first digital sequence (m=1 is the simplest); and
(3) the periodic sequence 901 modulates the interferometer phase with a peak-to-peak modulation depth of pi/2 radians, where the interferometer phase, Delta(phi_(ij))=phi(i)−phi_(j), and i and j are two interferometer paths of interest, i.e., paths of the first beam and the second beam.

As described hereinbefore, the system 100 generates zero-correlation at spurious delays based on the correlation profile of the first digital sequence. Accordingly, the homodyne system is configured to modify previous methods/processes of DEHoI (in which a 4 level modulation scheme required degraded correlation of two binary sequences to generate a 4 level QPSK sequence). DEHoI uses 4 levels to allow for sampling of all four quadratures within the complex plane. Previous methods/processes may have used two random sequences to sample these quadratures pseudorandomly, as shown in FIGS. 7(c) and 7(d), and the 4-level code samples either I or Q, in either the positive or negative direction. In contrast, the homodyne system described with reference to FIGS. 9A to 9D, including the predictable, repetitive/periodic, deterministic phase modulation of the PRN sequence (i.e., summed in phase), measures both I and Q for each code symbol, so the homodyne digital sequence 903 uses only one random sequence (instead of the previous two random sequences in previous method/process) and one periodic modulation, the period sequence 901, such as a square or sinusoidal modulation. By setting the frequency of the periodic sequence 901 (f_(IQ)) substantially equal to the frequency of the first digital sequence 401 (f_c), both quadratures are sampled evenly for each pseudo-random symbol, as shown in FIGS. 7(a) and 7(b), and the homodyne system can reconstruct the correlation for both quadratures yielding the I/Q projections as shown in FIG. 8, thus retaining the correlation profile afforded by the offset modulation/demodulation, with cancellation of spurious crosstalk at delays away from the signal of interest which is analogous to the heterodyne system. As shown in FIG. 8, the offset demodulation (top and middle) when summed lead to a cancellation of the cross-talk seen outside the delay of interest (bottom). In FIG. 8, the negative correlation at delay 8 is due to the correlation profile of A1 sequences described hereinbefore.

The homodyne system may be configured for encoding only one of the interferometer paths, e.g., the signal beam. Single decoding includes interferometers that only encode one of the interferometer paths, typically the signal beam. This includes where there are multiple signal beams, all encoded and measured against a single unencoded reference beam (the “local oscillator” or LO beam). In this configuration, the homodyne sequence 903 includes the first digital sequence 401 and the periodic sequence 901. The first digital sequence 401 may be selected to have a code modulation depth of +/−pi/2, and the periodic sequence 901 may be selected to have a code modulation depth of +/−pi/4. The first digital sequence 401 can be any with a high correlation for a single delay, including M-sequences, A1-sequences and A2-sequences. As shown in FIG. 12, an example of the homodyne sequence 903 (“QPSK”) can include a combination of the periodic sequence 901 (“Code 1”) and the first digital sequence 401 (“Code 2”). The QPSK sequence is a 4 level code for DEHoI that is compatible with offset modulation/demodulation.

Homodyne System with Offset Demodulation Using Parallel Demodulation/Decoding Channels

As shown in FIG. 9A, a homodyne system with offset demodulation using parallel demodulation/decoding channels (“system 900A”) includes:
a sequence stage 904 that combines the first digital sequence 401 in phase with the period sequence 901 to form the homodyne sequence 903 described hereinbefore;
a modulation stage 906 configured the same as the modulation stage 404 of the system 400A (albeit using the homodyne sequence 903 instead of just the first digital sequence 401 as in system 400A);
an IQ projection stage 908 that includes:
   the first signal delay T1 to delay the homodyne sequence 903 by substantially the signal delay Ts, and
   a pair of modules 918 configured to compute a sequence of the cosine values and a sequence of the sine values of the homodyne sequence 903 to form respectively an in-phase homodyne sequence 920I and a quadrature homodyne sequence 920Q (which is orthogonal to the in-phase homodyne sequence 920I),
an offset demodulation stage 910A that is connected to the IQ projection stage 908 to receive the in-phase homodyne sequence 920I and the quadrature homodyne sequence 920Q, and that is connected to the modulation stage 906 to receive interference signal, and that includes:
   an in-phase instance of the second delay T2 configured to provide an in-phase second digital sequence by time-delaying the in-phase homodyne sequence 920I by substantially To,
   a quadrature instance of the second delay T2 configured to provide a quadrature second digital sequence by time-delaying the quadrature homodyne sequence 920Q by substantially To,
   an in-phase pair of parallel demodulators 922A1I,922A2I that receive and demodulate the interference signal using the in-phase homodyne sequence 920I (to generate a first in-phase decoding output 924A1I “I-signal”) and using the in-phase second digital sequence (to generate a second in-phase decoding output 924A2I “I-offset”), and
   a quadrature pair of parallel demodulators 922A1Q,922A2Q that receive and demodulate the interference signal using the quadrature homodyne sequence 920Q (to generate a first quadrature decoding output 924A 1Q “Q-signal”) and using the quadrature second digital sequence (to generate a second quadrature decoding output 924A2Q “Q-offset”);
a correlation reconstruction stage 912 that is connected to the offset demodulation stage 910A to receive the first in-phase decoding output 924A1I (“I-signal”), the second in-phase decoding output 924A2I (“I-offset”), the first quadrature decoding output 924A1Q (“Q-signal”), and the second quadrature decoding output 924A2Q (“Q-offset”), and that includes an in-phase linear algebraic module 926I and a quadrature linear algebraic module 926Q, each configured to perform the selected linear algebraic operation (#) on the plurality of decoding outputs 924A1,924A2 for each of the in-phase and quadrature modules 926I,926Q, to form a (final, combined) in-phase decoding output 9281 and a (final, combined) quadrature decoding output 928Q, i.e., outputs from the correlation reconstruction stage 912;
a code averaging stage 914 that is connected to the correlation reconstruction stage 912 to receive the outputs from the correlation reconstruction stage 912, and including an in-phase low pass filter 930I and a quadrature low pass filter 930Q that perform code averaging on the in-phase decoding output 9281 and on the quadrature decoding output 928Q to respectively generate an in-phase baseband signal 9321 and a quadrature baseband signal 932Q; and
a phase recovery stage 916 that is connected to the code averaging stage 914 to receive the in-phase baseband signal 9321 and the quadrature baseband signal 932Q, and that includes a phase-unwrap module 934 that is configured to determine/generate/recover the interferometer phase (i.e., optical phase measurement) from a combination of the in-phase baseband signal 9321 and the quadrature baseband signal 932Q, e.g., using an arctan operation.

The pair of modules 918 may be regarded as computing IQ coefficients that scale the input signal (the homodyne sequence 903 delayed by T1) according to the IQ projection, resulting in measurements of I and Q quadratures at the signal and offset delays. The correlation is reconstructed by performing the linear algebraic operation (#) on the two demodulation paths (in the correlation reconstruction stage 912), before averaging (in the code averaging stage 914) and the phase reconstruction (in the phase recovery stage 916). Prior to the demodulation, the homodyne system computes the IQ projection from the combination of the first digital sequence 401 and the period sequence 901 by summing the first digital sequence 401 and the period sequence 901, and then computing their cosine (I) and sine (Q) projections, which form the IQ coefficients 920I,920Q. The IQ projection includes two weighting coefficients (I & Q) which are then delayed, and used to scale the input signal. As per the offset demodulation described hereinbefore, this process is parallelized for the two delays (T1 and T1+T2) depending on the properties of the first digital sequence 401 as described hereinbefore (e.g., by selecting an A1-sequence and selecting a value for “k” and one of the linear superposition relationships described hereinbefore). Following this, the output from the two demodulation delays is processed according to the linear algebraic operation (#) (e.g., summed) and the final I/Q output is filtered to recover the code correlation. The interferometric phase is computed by taking the arctangent of the filtered I/Q output. The code averaging stage 914 and the phase recovery stage 916 form the phase output element that generates the interferometer phase from the decoding output

The low pass filters 930I,930Q are code filters defined by the first digital sequence 401 configured to compute the autocorrelation of each channel with a kernel length equal to the length of the first digital sequence 401. The low pass filters 930I,930Q act as integrators to compute the respective baseband signals 9321, 932Q. Together with the demodulators 922A1I, 922A2I, 922A1Q, 922A2Q, the low pass filters 930I, 930Q compute the cross correlation of the signals received by the demodulators 922A1I, 922A2I, 922A1Q,922A2Q.

As shown in FIG. 10, an experimental example of the homodyne system 900A can be configured to demonstrate/quantify spurious noise suppression using a three arm Mach Zehnder interferometer with modulators in the two first optical paths (i.e., a homodyne variant of the heterodyne setup described with reference to FIG. 5 hereinbefore). As shown in FIG. 10, the homodyne system includes a reference arm (second optical path), and a signal arm and a spurious signal arm (both arms of the first optical path). As shown in FIG. 10, the two signal arms include modulators (“EOM”) that are modulated with the QPSK code (“QPSK”) at a selected first or second delay (“T_s1” or “T_s2”) including a combination of the first modulation sequence (e.g., an A1-sequence) and the IQ modulation described hereinbefore. The delay may be due to different delays at the point of modulation. Alternatively, the shared modulator 108 for both signal arms may be used, e.g., with the first and second delay being achieved through a time delay element (delta) 120 providing an optical length difference between the two arms 114, 106, thus providing different travel times (physical lengths) for the two signal arms. The signal arms combine with the homodyne reference arm at the photodetector, which is connected to the processing (“decoding”) system described with reference to FIG. 9A to recover signal 1 and signal 2 substantially free from cross talk or spurious interference from signals with delays differing from that of the desired signal.

In an experimental homodyne system, the signal and spurious signal arms were modulated with sinusoidal signals at different frequencies (220 Hz and 185 Hz respectively), and the interferometer readout compared the performance of a selected modulation sequence with and without offset demodulation by measuring the phase spectral density of the readout, e.g., as shown in FIG. 11, with the use of offset demodulation, the left hand peak at 185 Hz substantially disappears, and thus the undesirable trace was substantially suppressed (by more than 70 dB), potentially limited only by the noise floor of the experiment.

Homodyne System with Offset Demodulation Using a Compound Digital Sequence

As shown in FIG. 9B, the homodyne system with offset demodulation using a compound digital sequence (“system 900B”) includes:
the sequence stage 904 of system 900A;
the modulation stage 906 of system 900A;
a correlation construction stage 934 connected to the sequence stage 904 that is configured the same as the correlation construction stage 408C, except it receives the homodyne sequence 903 (instead of just the first digital sequence in 408C), to form a compound homodyne sequence 905;
the IQ projection stage 908 of system 900A, except it receives the compound homodyne sequence 905 to generate an in-phase compound homodyne sequence 9361 and a quadrature compound homodyne sequence 936Q:
an offset demodulation stage 910B that is connected to the IQ projection stage 908 to receive the in-phase compound homodyne sequence 9361 and the quadrature compound homodyne sequence 936Q, and that is connected to the modulation stage 906 to receive the interference signal, and that includes:
   an in-phase demodulator 9221 that receives and demodulates the interference signal using the in-phase compound homodyne sequence 9361 (to generate an in-phase decoding output 924I), and
   a quadrature demodulator 922Q that receives and demodulates the interference signal using the quadrature compound homodyne sequence 936Q (to generate a quadrature decoding output 924Q;
the code averaging stage 914 of system 900A, except that it is connected to the offset demodulation stage 910B to receive the in-phase decoding output 924I and the quadrature decoding output 924Q; and
the phase recovery stage 916 of system 900A.

Together with the demodulators 9221, 922Q, the low pass filters 930I, 930Q compute the cross correlation of the signals received by the demodulators 9221, 922Q.

Homodyne System with Offset Modulation Using a Compound Digital Sequence

As shown in FIG. 9C, the homodyne system with offset modulation using a compound digital sequence (“system 900C”) includes:
the sequence stage 904 of system 900A;
the correlation construction stage 934 of system 900B;
an offset modulation stage 938 that is connected to the correlation construction stage 934 to receive the compound homodyne sequence 905, and configured the same as the modulation stage 404 of the system 400A (albeit using the compound homodyne sequence 905 instead of just the first digital sequence 401 as in system 400A);
the IQ projection stage 908 of system 900A to generate the in-phase homodyne sequence 920I and the quadrature homodyne sequence 920Q:
a demodulation stage 940 that is connected to the IQ projection stage 908 to receive the in-phase homodyne sequence 920I and the quadrature homodyne sequence 920Q, and that is connected to the offset modulation stage 938 to receive the (offset modulated) interference signal, and that includes:
   the in-phase demodulator 9221 that receives and demodulates the interference signal using the in-phase homodyne sequence 920I (to generate the in-phase decoding output 924I), and
   the quadrature demodulator 922Q that receives and demodulates the interference signal using the quadrature homodyne sequence 920Q (to generate the quadrature decoding output 924Q);
the code averaging stage 914 of the system 900A, except that it is connected to the demodulation stage 940 to receive the in-phase decoding output 924I and the quadrature decoding output 924Q; and
the phase recovery stage 916 of the system 900A.

As in system 900B, the demodulators 9221, 922Q together with the low pass filters 930I, 930Q compute the cross correlation of the signals received by the demodulators 9221, 922Q.

Homodyne System with Offset Modulation Using Parallel Modulation/Encoding Channels

As shown in FIG. 9D, the homodyne system with offset modulation using a parallel modulation/encoding channels (“system 900D”) includes:
the sequence stage 904 of system 900A;
an offset modulation stage 942 that is the same as the offset modulation stage 440 of the system 400D, except the input is the homodyne sequence 903 (instead of merely the first digital sequence 401 in the offset modulation stage 440);
a correlation reconstruction stage 944 that is the same as the correlation reconstruction stage 408D of the system 400D;
the IQ projection stage 908 of the system 900A to generate the in-phase homodyne sequence 920I and the quadrature homodyne sequence 920Q;
the demodulation stage 940 of the system 900C;
the code averaging stage 914 of the system 900A, except that it is connected to the demodulation stage 940 to receive the in-phase decoding output 924I and the quadrature decoding output 924Q; and
the phase recovery stage 916 of the system 900A.

As in systems 900B and 900C, the demodulators 9221, 922Q together with the low pass filters 930I, 930Q compute the cross correlation of the signals received by the demodulators 9221, 922Q.

### Multiple Decoding Homodyne System

In a multiple decoding systems (i.e., including an encoding cascade (in series) and a decoding cascade, as described briefly with reference to FIG. 1E hereinbefore, e.g., for double decoding systems as shown in FIGS. 1C and 1D) both the signal and reference paths may be encoded with homodyne modulation, and therefore the interferometer phase Delta phi_(ij) results in the superposition of two codes, or multiples thereof. For multiple path systems, the combination of the codes satisfies the three properties described hereinbefore, which results in a code delay for two interferometer paths of interest, i and j, as follows (“Equation 1”)

$${τ}_{i} - {τ}_{j} = \frac{1}{{f}_{c}} ( N \pm \frac{1}{2} ) \\ {Δτ}_{ij} = \frac{1}{{f}_{c}} ( N \pm \frac{1}{2} ) \qquad ( 1 )$$

where fc is the symbol (chip) frequency and tau_i and tau_j are the delays for the two interferometer paths of interest, and N is a free parameter which can be any integer value, representing an integer number of code symbols (chips) that elapse between the two paths.

For interferometer optical paths of interest i and j, the appropriate modulation frequency for given interferometer path length differences can be selected according to the following relationship (“Equation 2”):

$$Δ {L}_{ij} = \frac{c {Δτ}_{ij}}{n} \\ Δ {L}_{ij} = \frac{c}{{nf}_{c}} ( N \pm \frac{1}{2} ) \qquad ( 2 )$$

where DeltaL_(ij) is the physical path length difference between optical paths i and j, n is the refractive index of the medium of propagation, c the speed of light and fc the symbol (chip) frequency.

As the IQ modulation is periodic over the symbol period, the additional advance/lag of ½ one symbol ensures that the IQ modulation between the two beams of the interferometer being synthesised is substantially 180 degrees out of phase. The interferometer phase can therefore be defined as (“Equation 3”):

$${Δ∅}_{ij} = {∅}_{i} - {∅}_{j} \\ {Δ∅}_{ij} = {c}_{PRN} ( t - {τ}_{i} ) + {c}_{IQ} ( t - {τ}_{i} ) - [ {c}_{PRN} ( t - {τ}_{j} ) + {c}_{IQ} ( t - {τ}_{ij} ) ] \\ {Δ∅}_{ij} = {c}_{PRN} ( t - {τ}_{i} ) - {c}_{PRN} ( t - {τ}_{j} ) - {c}_{IQ} ( t - {τ}_{i} ) - {c}_{IQ} ( t + {Δτ}_{ij} - {τ}_{i} ) \\ {Δ∅}_{ij} = {c}_{PRN} ( t - {τ}_{i} ) - {c}_{PRN} ( t - {τ}_{j} ) - {c}_{IQ} ( t - {τ}_{i} ) + {c}_{IQ} ( t - {τ}_{i} ) \\ {Δ∅}_{ij} = \underbrace{{c}_{PRN} ( t - {τ}_{i} ) - {c}_{PRN} ( t - {τ}_{j} )}_{PRN encoding} + \underbrace{2 {c}_{IQ} ( t - {τ}_{i} )}_{IQ modulation} \qquad ( 3 )$$

As shown in Equation 3, in the double decoding arrangement, the IQ modulation depth is doubled at the interferometer output when using the code delay relation in Equation 1. In order for the IQ modulation depth from the third of the three properties hereinbefore to be satisfied, the initial modulation depth of the IQ modulation is halved (from +/−pi/4) to +/−pi/8 for double decoding.

In some implementations, the two interferometer paths are not modulated with one code each. For example, a Sagnac interferometer includes both clockwise (CW) and counterclockwise (CCW) modulators, each of which encode the CW and CCW paths, albeit at different times provided by the time delay element (delta) 120 as shown in FIG. 1E. In the case of a Sagnac interferometer, each of the interferometer beams is therefore modulated twice prior to interfering. As the same three properties stated previously apply in this situation, the selected modulation depths for the IQ modulation is halved to +/−pi/16.

As further modulators are added in more complex architectures, the selected modulation depths for the first digital sequence 401 and the periodic sequence 901 are divided to provide the correct modulation depth at the interferometer output, fulfilling the three requirements.

### Implementations

The system 100 with offset processing may be configured for a plurality of applications including: multiplexed vibrometry and acoustic sensing (DEHeI and DEHoI), optical phased arrays (DEHeI), optical spectroscopy (DEHoI), inertial navigation (DEHoI), laser stabilisation, high power laser generation using optical phased arrays, and gravitational wave interferometry.

### Interpretation

“Homodyne detection” includes extracting information encoded as modulation of the phase and/or frequency of an oscillating signal, by comparing that signal with a standard oscillation that would be identical to the signal if it carried null information. “Homodyne” signifies a single frequency, in contrast to the dual frequencies employed in heterodyne detection. In optical interferometry, “homodyne” signifies that the reference radiation (i.e., the local oscillator) is derived from the same source as the signal before the modulating process. For example, in a laser scattering measurement, the laser beam is split into two parts. One is the local oscillator and the other is sent to the system to be probed. The scattered light is then mixed with the local oscillator on the detector. This arrangement has the advantage of being insensitive to fluctuations in the frequency of the laser. Usually the scattered beam will be weak, in which case the (nearly) steady component of the detector output is a good measure of the instantaneous local oscillator intensity and therefore can be used to compensate for any fluctuations in the intensity of the laser.

“Phase-shift keying” (PSK) is a digital modulation process which conveys data by changing (modulating) the phase of a constant frequency reference signal (the carrier wave). The modulation is accomplished by varying the sine and cosine inputs at a precise time. PSK uses a finite number of phases, each assigned a unique pattern of binary digits. One example is “quadrature phase-shift keying” (QPSK), in which four phases are used, mutually spaced by substantially 90 degrees in phase. QPSK can be viewed as two independently modulated quadrature carriers. QPSK transmits twice the data rate in a given bandwidth compared to binary PSK or BPSK (which uses two phases) at the same bit error rate.

Many modifications will be apparent to those skilled in the art without departing from the scope of the present invention.

The presence of “/” in a FIG. or text herein is understood to mean “and/or” unless otherwise indicated, i.e., “X/Y” is understood to mean “X, or Y, or both X and Y”. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” or “substantially” can indicate a percentage greater than or equal to 90%, for instance, 92.5%, 95%, 97.5%, 99%, or 100%.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A system including:
an optical source configured to provide at least one first optical beam and at least one second optical beam;
an interferometer including:
at least one first optical path for the at least one first optical beam,
at least one second optical path for the at least one second optical beam,
at least one modulator configured to modulate the first optical beam and/or the second optical beam based on at least one digital modulation sequence, and
an optical combiner/detector configured to detect interference fringes between the first and second optical beams after the first and second optical beams have traversed the first and second optical paths; and
an electronic processing system including:
a receiver element (“receiver”) configured to receive from the optical combiner/detector an interference signal that is indicative of an interferometer phase, which is an optical phase difference between the first and second optical beams,
a demodulator configured to obtain/generate at least one decoding output by demodulating the interference signal using at least one digital demodulation sequence that is associated with the at least one digital modulation sequence, and
a phase output element configured to determine/generate the interferometer phase based on the at least one decoding output,
wherein the at least one digital modulation sequence or the at least one digital demodulation sequence is based on a plurality of digital sequences, which include a first digital sequence and a second digital sequence, wherein the second digital sequence is based on a time-shifted version of the first digital sequence by an offset delay, and wherein:
the offset delay is selected to correspond to a delay not already associated with a physical signal in the interferometer; or
the at least one digital modulation sequence or the at least one digital demodulation sequence includes a compound digital sequence based on the first digital sequence and the second digital sequence combined according to a linear algebraic operation; or
the first optical beam and/or the second optical beam are modulated and combined according to a linear algebraic operation; or
a plurality of the at least one decoding output are combined according to a linear algebraic operation.

2. The system of claim 1, including a sequence source configured to generate the first digital sequence, the second digital sequence, and/or the compound digital sequence for the modulation and/or the demodulation, optionally wherein the sequence source is configured to generate the second digital sequence by time shifting the first modulation sequence by the offset delay.

3. The system of claim 2, wherein the sequence source includes a pseudo-random number generator and/or a linear feedback shift register, optionally on a Field-Programmable Gate Array (FPGA) or a digital signal processing (DSP) module, configured to generate the first digital sequence, and optionally the second digital sequence.

4. The system of claim 1, wherein the electronic processing system is configured to generate the second digital sequence by time shifting the first modulation sequence by the offset delay.

5. The system of claim 1 including any one or more of:
an optical splitter configured to split a light beam from the optical source into the first optical beam and the second optical beam, or a plurality of phase-coherent optical sources that provide the first optical beam and/or the second optical beam;
a first modulator configured to modulate the first optical beam in the first optical path based on the digital modulation sequence;
an optical length difference between the first optical path and the second optical path to provide different travel times for the first optical beam and the second optical beam, and a modulator arranged and configured to modulate both the first optical beam and the second optical beam before they are split by a/the optical splitter;
a first modulator driven by a first signal generator with a first version of the digital modulation sequence, and a second modulator driven by a second signal generator with a second version of the digital modulation sequence that is a digitally delayed version of the first version; and
a Sagnac interferometer with two modulators that both modulate both of the first and second optical beams, and a time delay element in an optical path between the two modulators.

6. The system of claim 1, wherein the first digital sequence is configured/adapted/selected to have an autocorrelation such that a sample-by-sample linear combination according to the linear algebraic operation of two time-shifted versions of the autocorrelation substantially equal zero for non-signal delays.

7. The system of claim 1, wherein the plurality of the at least one decoding output includes: a first decoding output and a second decoding output.

8. The system of claim 7, wherein the first decoding output and the second decoding output are combined according to the linear algebraic operation.

9. The system of claim 7, wherein the electronic processing system is configured to obtain/generate the first decoding output and the second decoding output in parallel, optionally wherein the electronic processing system includes two parallel demodulation channels, including: a first demodulation channel configured to obtain the first decoding output by the demodulating of the interference signal using the first digital sequence, and a second demodulation channel configured to obtain the second decoding output by the demodulating of the interference signal using the second digital sequence.

10. The system of claim 1, wherein the first digital sequence has a sequence length and a symbol rate selected based on a predetermined required bandwidth of the interferometer.

11. The system of claim 1, wherein the first digital sequence has a physical sequence length that is at least as large as a selected range of distance measurements to be made by the interferometer.

12. The system of claim 1, wherein the first digital sequence has a physical sequence length that is substantially equal to or larger than a larger of the at least one first optical path and the at least one second optical path, optionally wherein the offset delay is selected to represent a distance equal to or larger than the at least one first optical path and the at least one second optical path.

13. The system of claim 1, wherein the offset delay and the linear algebraic operation are selected based on properties of the first digital sequence.

14. The system of claim 13, wherein the first digital sequence is in the form of an A1-sequence or an A2-sequence, and the linear algebraic operation includes an addition or a subtraction, and/or the offset delay includes: 2k+1 or 2k+2 symbols, or 4k+4 or 4k+4 symbols (wherein k is an integer number), or 1 symbol.

15. The system of claim 13, wherein the first digital sequence is in the form an M-sequence with a sequence length, and the linear algebraic operation includes a subtraction, and/or the offset delay includes a value equal or greater than 1 symbol and less than the sequence length.

16. The system of claim 1, wherein the first digital sequence includes a pseudo-random sequence, and/or wherein the first digital sequence modulates the interferometer phase with a peak-to-peak modulation depth of up to pi radians.

17. The system of claim 1, wherein the compound digital sequence includes a linear combination of pseudo-random sequences,
and/or wherein the compound digital sequence modulates the interferometer phase with a peak-to-peak modulation depth of up to 2pi radians.

18. The system of claim 1, wherein the interferometer is configured for digitally-enhanced homodyne interferometry (DEHoI), and the first digital sequence includes a pseudo-random sequence that modulates equally both an in-phase component and a quadrature component of the first optical beam and/or the second optical beam such that autocorrelation properties of the pseudo-random sequence are independently preserved in both the in-phase component and the quadrature component and in in-phase and quadrature readouts of the electronic processing system.

19. The system of claim 18, wherein the first digital sequence includes: a predictable, repetitive/periodic, deterministic, non-random phase modulation (“regular modulation”) combined with the pseudo-random sequence, wherein the regular modulation has an integer number of periods and is synchronous with the symbol frequency of the first digital modulation sequence, optionally wherein the regular modulation modulates the interferometer phase with a peak-to-peak modulation depth of up to pi/2 radians.

20. The system of claim 18, wherein the compound digital sequence includes: a predictable, repetitive/periodic, deterministic, non-random phase modulation (“regular modulation”) combined with the first digital sequence and the second digital sequence combined according to the linear algebraic operation, wherein the regular modulation has an integer number of periods and is synchronous with the symbol frequency of the compound digital sequence, optionally wherein the regular modulation modulates the interferometer phase with a peak-to-peak modulation depth of up to pi/2 radians.

21. A method comprising:
providing at least one first optical beam and at least one second optical beam;
modulating the first optical beam and/or the second optical beam based on at least one digital modulation sequence;
detecting interference fringes between the first and second optical beams after the first and second optical beams have traversed an interferometer and been modulated;
receiving an interference signal that is indicative of an optical phase difference between the first and second optical beams;
obtaining/generating at least one decoding output by demodulating the interference signal using at least one digital demodulation sequence that is associated with the at least one digital modulation sequence; and
determining the interferometer phase based on the at least one decoding output,
wherein the at least one digital modulation sequence or the at least one digital demodulation sequence is based on a plurality of digital sequences, which include a first digital sequence and a second digital sequence, wherein the second digital sequence is based on a time-shifted version of the first digital sequence by an offset delay, and
wherein:
the offset delay is selected to correspond to a delay not already associated with a physical signal in the interferometer; or
the at least one digital modulation sequence or the at least one digital demodulation sequence includes a compound digital sequence based on the first digital sequence and the second digital sequence combined according to a linear algebraic operation; or
the first optical beam and/or the second optical beam are modulated and combined according to a linear algebraic operation; or
a plurality of the at least one decoding output are combined according to a linear algebraic operation.
